(19) United States
(12) Patent Application Publication
(10) Pub. No.: US 2007/0047523 A1
(43) Pub. Date: Mar. 1, 2007

(54) Method and system for call-setup triggered push content

(75) Inventor: John Yue Jun Jiang, Danville, CA (US)

Correspondence Address: ARENT FOX PLLC, 1050 CONNECTICUT AVENUE, N.W., SUITE 400, WASHINGTON, DC, 20036, US

(73) Assignee: Roamware, Inc.

(21) Appl. No.: 11/443,434

(22) Filed: May 31, 2006

Related U.S. Application Data
(63) Continuation-in-part of application No. 09/932,439, filed on Aug. 16, 2001, now Pat. No. 7,092,370.
(60) Provisional application No. 60/595,032, filed on May 31, 2005.

(51) Int. Cl. H04L 12/66

(52) U.S. Cl. 370/352

(57) ABSTRACT

The present invention provides a method for providing a call set-up triggered push content to at least one receiving party via a first telecommunication network. The method includes performing a call control function in response to a call set-up from a calling party to a called party. The call control function operates on at least one call parameter. The method further includes applying application logic based upon the at least one call parameter for determining the at least one receiving party and the corresponding push content details of the at least one receiving party, and delivering the push content specified by the push content details to the at least one receiving party. The method further addresses inter-working between operators when the calling and called parties are subscribers of different operators.

### CROSS REFERENCE TO RELATED APPLICATION

### Related Applications

This application claims priority from U.S. Provisional Patent Application Ser. No. 60/595,032 entitled Personalized Ring Forward Tone Service and its implementation and Inter-working architectures, filed May 31, 2005 and is a continuation-in-part of United States Patent Application entitled “Method and System for Wireless Voice Channel/Data Channel Integration” application Ser. No. 09/932,439 filed on Aug. 16, 2001, claiming priority from Aug. 18, 2000. Both of those related patent applications are incorporated herein by this reference in their entirety.

### BACKGROUND OF THE INVENTION

1. Field of the Invention

The present invention generally relates to systems and services that provide push content. More specifically, the present invention relates to call setup triggered push content providing systems and methods of handling call flow for these systems.

2. Background of the Technology

Call set up—the moment at which a calling party initiates a request for a conversation with a called party via telecommunications, and the attendant telecommunications infrastructure and process for prosecuting that request—is a special moment in which the attention of at least two parties is seized for an urgent need to interact. The rapid diffusion of digital telecommunications through the Internet and today's digital public wireless mobile networks has given rise to an often observed reality that conversation—phone calls—are just one form of digital content now provided by an infrastructure well-equipped to transport any type of content. Yet the state of the art in public telecommunications does not yet provide convenient means of extending the call set up infrastructure—originally designed for person-to-person conversation—into a platform for permitting any party to call set up (called party, calling party, network operator or other) to distribute any form of digital content during that attention-grabbing moment. There is a need in the art to avail users of the attention-getting moment of call setup to push, receive or share especially relevant content in addition to or instead of the ordinary phone call.

Content “push” is one such frequently-described means of distributing personally relevant digital content. “Push” technology, also called “server push,” typically has been used to describe an internet-based content delivery system where information is delivered from a central server to a client station based upon a predefined set of request parameters outlined by the client computer. Illustratively, a client computer user such as a home desktop user would subscribe to various information topics provided by a content provider and as that content is created by the content provider, such information is “pushed” or delivered across the internet to the desktop user and displayed on the users' computer.

In addition to the internet-based push technology, the push concept is also used for providing mobile pushed content services. The mobile push content services include SMS push service, WAP push service, push information service, missed call alerts, and push email service which are highly popular services and major sources of revenue for mobile operators. Another mobile push content service, namely, mobile TV, is a push broadcast service in demand. Recently, the mobile operators have introduced multimedia push services such as multiple channels of multimedia information, video and TV for downloading the push content to mobile devices in idle mode for off-line viewing. An example of such a service are client/server products known in the art for pushing network-based media content to handsets during downtime, such as the “Silverstripe” solution offered by Bamboo Mediacasting (www.bamboomc.com).

Some pushed content services known in the art even have discussed a focus on pushing content to a called party during a call set up. The pushed content is played at the called party device when an incoming call arrives. However, because a convenient integration into existing call set up apparatus has not been known, those push-to-mobile services have been limited in many important ways to point solutions of particular types of content, and capable of being addressed by or to limited parties.

The examples of how the art is limited by the absence of an adequate extension of installed call set up means are manifold. By non-limiting example, the current art will not deliver a music tone defined by the called party to ring on the calling party's device instantaneously during call set up. Further, the push content services known in the art do not enable a calling party to view the called party's latest profile (for example, pictures, blogs etc), or enable a called party to inform his calling friends of his new address. Similarly, the calling party is not able to communicate with multiple parties in a call-setup such as broadcasting to a group of friends stored in his handset's phonebook in one broadcast session to inform them of his new address. Also, it is not possible to play push content, for example, ring tone, before the incoming call reaches the called party device.

None of the push content services allow the push content to be played at the calling/called party device immediately as soon as the call is allowed (for example, in streaming mode), as would be required for a caller-defined ringtone, ringback tone, or for simultaneous matching audio for ringtone and ringback tone. Further, the push content services do not address the case where two or more simultaneous calls are coming and the caller IDs are unknown. Also, it is not possible to push content to a non-attentive party, for example, a third party. Thus, the known push services are unable to attract the user's attention. Moreover, state of the art call-setup does not offer a layer of abstraction that permits any sort of content experience to be triggered by the personal attention-grabbing moment represented by call-setup.

From an implementation perspective, the push content services known in the art typically allow for content to be pushed only in a single direction in an in-band manner (i.e. having both voice and push content in the same circuit switched or packet switched channel) and require changes (for example, by adding special additional parameters) to the existing signaling protocols (for example, ISUP, SIP etc). This requires impractical changes on networks and devices. By way of non-limiting example, a known push content service, known as “push-to-talk”, permits a calling party to talk instantly to a called party without involving the called party to answer the call and hear the calling party. State of the art push to talk service is generally, implemented as a half-duplex service like a walkie-talkie service for mobile phones, and by definition occurs without call set up (phone ringing, requiring a called party to accept the call, etc.). Although call-setup based push-to-talk has been proposed in the art, a generic extension of call-setup architecture to permit client-less push to talk is still needed.

Another known push content service relating to personal “ringback tone” service allows the calling party to hear a ring tone (e.g. music, audible) personalized by the called party but played at the network via the bearer path of the call rather than on the calling device side. Because this is not established as a separate content communication, but merely as one-way audio played over the circuit, state of the art ringback tone does not typically permit, for example, a calling party to download or designate that ringback tone, audio file or corresponding ringtone for his own future use. Also, that ringback tone content is limited to audio content and cannot be viewed by ordinary devices. In yet another service relating to caller-defined ring tone service, the called party hears a ring tone (e.g. music, audible) personalized by the calling party but played on the called party's device. However, previously proposed services generally cannot be implemented in today's network infrastructure as it requires both protocol changes and network elements changes.

Thus, there is a need for multi-directional addressing of content to be distributed or made immediately available during call set up, via convenient extensions of today's call set up architecture. The unmet demand is to abstract call setup beyond the limited purpose of establishing a person-to-person voice communication session into a generalized opportunity to deliver personalized media content of any sort that may be relevant to the personal attention-grabbing moment that call-setup represents. Such a solution should empower users to designate network-based content, or directly push self-generated content to a receiving party at the moment of call set up. The ideal solution will comprise an efficient extension of state of the art call setup infrastructure, and will allow any party to the call set up transaction (network, called party, calling party or other parties) to address content to any of those other parties to the call set up event.

### SUMMARY OF THE INVENTION

The present invention enables telecommunications networks originally designed for person-to-person conversations to offer any type of content or personalized media experience during the personal “attention grabbing” moment represented by extending the installed apparatus for call set up. That personalized experienced can be instantiated or designated by any party to the call being set up, by the network itself or by others. Flexible means are provided for establishing this extension to state of the art call set up infrastructure widely available in today's common carrier networks.

The present invention provides a method for pushing content to at least one receiving party via a telecommunication network in the context of a call setup event. The method includes performing a call control function in response to a call setup initiated by a calling party to a called party. The call control function operates on at least one call parameter. The method further includes applying an application logic based upon the at least one call parameter for determining at least one receiving party and the corresponding push content details of the at least one receiving party, and delivering the push content specified in the push content details to the at least one receiving party. That receiving party can be the calling or the called party, or another party. That at least one parameter can be set by the calling party, the called party, the network, a third party, pre-configured, a priori, based on rules, or set by any party.

In another aspect, the present invention provides a system for providing call setup triggered push content to at least one receiving party via a first telecommunication network. The system comprises a subscriber database, a network interface, an application module, and a content server. The subscriber database stores at least one subscriber profile and preference settings. The preference settings include the push content details of the subscriber. The network interface performs a call control function in response to a call setup. The call control function operates on at least one call parameter. The application module applies application logic based upon the at least one call parameter for determining the at least one receiving party and the corresponding push content details of the at least one receiving party. The content server delivers the push content specified in the push content details to the at least one receiving party.

### BRIEF DESCRIPTION OF DRAWINGS

In the drawings, the same or similar reference numbers identify similar elements or acts.

FIG. 1 is a flowchart depicting a method for providing push content, in accordance with an embodiment of the present invention.

FIG. 2 is a block diagram depicting a system for providing call setup triggered push content to at least one receiving party (not shown) in a telecommunications network, in accordance with an embodiment of the present invention.

FIG. 3 shows a database table depicting an exemplary subscription profile for a receiving party, in accordance with an embodiment of the present invention.

FIG. 4 shows the configuration of a receiving party profile channel, in accordance with an embodiment of the present invention.

FIG. 5 shows an exemplary configuration of a ring forward tone (RFT) channel by a receiving party, in accordance with an embodiment of the present invention.

FIG. 6 shows an example of a general push content permission control by a receiving party against a sending party, in accordance with an embodiment of the present invention.

FIG. 7 shows a table containing group definitions of a subscriber of CTPCS, in accordance with an embodiment of the present invention.

FIG. 8 depicts various options of supporting push content delivery to a device from CTPCS.

FIG. 9 illustrates an exemplary call flow based on an originating party call control.

FIG. 10 illustrates an exemplary call flow based on a terminating party call control.

FIG. 11 illustrates an exemplary signal flow of the interaction between a calling party A, a called party B and CTPCS while pushing content to the called party B in accordance with an embodiment of the present invention.

FIG. 12 illustrates an exemplary signal flow of the interaction between a calling party A, a called party B and CTPCS while pushing content to calling party A and called party B in accordance with an embodiment of the present invention.

FIG. 13 illustrates an exemplary signal flow depicting inter-working of call setup triggered push content service between operators for a pushed content to the called party.

FIG. 14 illustrates an exemplary signal flow depicting inter-working of call setup triggered push content service between operators for a pushed content to the called party of VPMN-2 and the calling party.

FIG. 15 depicts the inter-working of CTPCS of VPMN-1 and CTPCS of VPMN-2 where the defined content from called party B of VPMN-2 is being pushed to calling party A of VPMN-1.

FIG. 16 illustrates an exemplary call flow depicting called party call control for delivering calling party defined ring tones to the called party.

FIG. 17 illustrates an exemplary call flow depicting calling party call control for delivering a called party defined ring tone to the calling party.

FIG. 18 illustrates an exemplary call flow depicting inter-working between operators where a calling party A of VPMN-1 is calling a called party B of operator VPMN-2 with a calling party defined ring tone that is subscribed by the called party.

FIG. 19 describes news flash service of CTPCS with respect to a subscriber each time the subscriber makes a call in accordance with an embodiment of the present invention.

FIG. 20 illustrates profile information of a call party pushed to the other call party in either or both directions in accordance with an embodiment of the present invention.

FIG. 21 illustrates signal flow of the profile of called party being sent to the subscribed calling party in accordance with an embodiment of the present invention.

### DETAILED DESCRIPTION OF THE INVENTION

In the following description, like reference characters designate like or corresponding parts throughout the several views shown in the figures. Moreover, it will be understood that the illustrations are for the purpose of describing a particular exemplary embodiment of the invention and are not intended to limit the invention thereto.

In various embodiments, the receiving party includes a calling party, a called party, both the parties, a group of parties or a third party (for example, parents, spouses, schools, employers, clubs, police, other emergency services, mailing lists etc). In various embodiments, the call party includes a calling party, a called party and a third party. In various embodiments, the sending party is the party that defines the push content to be sent to one or more receiving parties. The sending party includes a calling party, a called party, a group of parties and a third party. In various embodiments, a subscriber is a person who has subscribed to a call setup triggered push content service. Based on different call events, the subscriber may be the called party, the calling party, or a third party.

The present invention provides a system and method for providing a call setup triggered push content to at least one receiving party. The call setup draws the attention of a calling party who is intending a call and possibly also the attention of a called party who is notified (via for example, a ring-tone or a vibration alert) of the call. In one embodiment, the push content subscribed by the receiving party (calling party or called party or third party) may be network-based provided by mobile operators or their content/service partners. In another embodiment, the push content subscribed by the receiving party may be uploaded by the calling party or the called party (the receiving device) at call-setup triggered push content system (CTPCS) for future personal usage or shared public usage. In yet another embodiment, the push content subscribed by the receiving party may be uploaded by other call party (for example, a third party) at the CTPCS. In yet another embodiment, the push content subscribed by the receiving party may be uploaded by a third party at the CTPCS. The push content may be uploaded at the CTPCS independent of a call or just prior to a call. In various embodiments, the push content may be delivered to the receiving party prior to the call being answered, while the call is in progress or after the call completion. The push content includes ring tones and multimedia information.

In an embodiment, the ring tone ringing on the calling party device may be defined either by the called party or the calling party (for example, top 5 ring tone downloads) at the CTPCS or the CTPCS (for example, a network-accessible “jukebox” or library of many content items). In another embodiment, the ring tone ringing on the called device may be defined by the calling party or the called party (for example, hip hop ring tone download only from jukebox) at the CTPCS or the CTPCS (for example, the jukebox).

In an embodiment, the present invention uses a voice channel to trigger voice communication when the calling party calls the called party. The voice call triggers a network application to start a session. This voice communication triggers a data communication of pushing content via (SMS or data channel such as GPRS or IMS or any other data channel) to the receiving device (calling party or called party or third or both or all). The receiving device can then play the content prior to the call being answered.

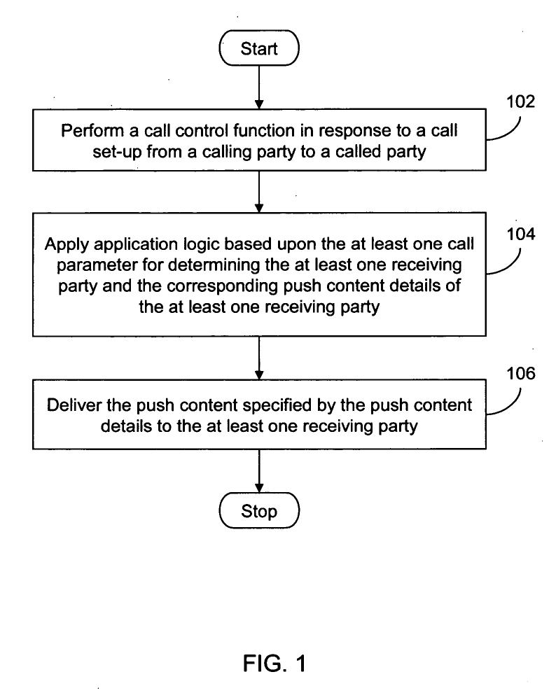

FIG. 1 is a flowchart depicting a method for providing push content, in accordance with an embodiment of the present invention. The method is invoked in response to a call setup request from a calling party to a called party. The call setup is initiated via the call setup request. The call setup includes time for which the calling party to wait for a call answer after dialing the called party and the waiting time of the called party before an incoming call is notified to the called party or before the called party answers or refuses the call. The call setup catches the attention of the called party due to for example, ringing/vibrating notification, and the attention of the calling party for requesting the call. Further, the method enables push content to be pushed to call parties' receiving devices (for example, a calling party, a called party or a third party) in either direction while the call setup is in progress, rather than when the call party receiving device is in an idle state.

In an embodiment of the present invention, at step 102, a call-setup triggered push content system (CTPCS) performs a call control function during the call setup from the calling party to the called party. The call control function operates on at least one call parameter which is made available for determining how the call or the push content will be identified, provisioned or delivered. Examples of call control parameters may be, but are not limited to, an application identifier, a calling party number, a calling party International Mobile Subscriber Identity (IMSI), a called party number, or a Visited Mobile Switching Center (VMSC) location.

Thereafter, at step 104, the CTPCS applies application logic to determine at least one receiving party and the corresponding push content details of the at least one receiving party based upon the at least one call parameter. In various embodiments, the receiving party includes a calling party, a called party, a third party and a group of parties. In an embodiment, call parties, subscribers, network operators, third parties or computer programs can define the push content details of each user of the CTPCS. In various embodiments of the invention, CTPCS stores the profile and preference settings of the receiving parties. The profile and preference settings may include, for example, the identity of the calling party, the identity of the called party, a third party identity, the call history information, time of the day, season, relationships, default order to play the push content in case of simultaneous incoming calls from, for example, unknown callers or push content and combinations thereof.

In one embodiment of the invention, a sending party defines the push content details to which the requested or delivered push content is to correspond. The sending party can be a calling party, a called party, the network operator, a third party or a group of parties.

In another embodiment of the invention, CTPCS may define the push content based on a history of calls of the at least one receiving party, or any other data observed about relevant call parties. A person skilled in the art will appreciate that the push content may be selected by the sending party in accordance with different application logic, for example, the push content may be selected at subscription time or during subscription life independent of a particular call or just prior to making a particular call.

Thereafter, at step 106, the push content specified in the push content details is delivered to the at least one receiving party. In one embodiment of the invention, the push content can include, by way of non-limiting example, a ring tone, a video tone, a news item, a stock report, a sports update, a quote of the day, a calling party profile, a called party profile, an audio file, a celebrity voice, a music item, a multimedia file, a television footage, an advertisement, incoming email headers, an information of calls related to other calling devices, or a combination thereof. The ring tone includes a telecommunication network defined ring tone, an operator defined ring tone, and a call party (for example, calling party or called party or third party) defined ring tone. During the delivery of the push content (at step 106) either streaming of the push content is performed, and/or the push content is downloaded at the receiving device.

In accordance with an embodiment, the push content may be delivered to the receiving party while the call setup is not complete. The push content is delivered/streamed and played to at least one receiving party while the call is initiated by the calling party and disconnected by the calling party without call completion. For example, if the calling party wishes to send a ring tone gift to the called party without talking, the calling party may make a call and disconnect the call after sending the ring tone to the called party without the call setup being complete. In an embodiment, the call setup may be a group call in which the calling party may trigger an information broadcast (e.g. he has moved to a new job) to a group of users.

The delivered push content can be played over a voice or data channel, or can be played using a client installed on the at least one receiving party. For example, that client may be designed to play content stored on the receiving device itself. In an embodiment, if two or more simultaneous calls are received, the delivered push content corresponding to the push content matched on caller ID and received from a known caller ID is played. In another embodiment, if unmatched push content and simultaneous incoming calls from unknown caller IDs are received, the delivered push is played in the order of incoming calls and incoming push contents.

In one embodiment of the invention, the receiving party has an option to override the push content. Also, the push content may be protected by a digital rights management (DRM) implementation. In various embodiments of the invention, the push content is delivered to the receiving party either before a call is answered, while a call is in progress and/or after the call is complete. In various embodiments of the invention, the delivering of the push content includes streaming of the push content and/or downloading of the push content at the receiving party. In accordance with an embodiment, the delivery of the push content (that is suspended due to a call being answered) is resumed after the call completion. In accordance with an embodiment, the process of delivering the push content may be influenced by an activity reported by a client present on the receiving party device. The activity may be a silent mode, a switched off ring forward tone mode, a stop interrupt by a subscriber, and/or a combination thereof. Also, at least one of storing, configuring, deleting, stopping, suspending, resuming and purchasing of the push content may be performed by the receiving party.

Examples of the push content may include by non-limiting example any of the following:
Calling party profile (e.g. interests, blogs, pictures, recent activities etc) for the called party to take peek before answering the call.
Called party profile (e.g. interests, blogs, recent activities (e.g. relocation, bought a house, had a baby, had a promotion, changed job, recent pictures etc.) for the calling party to take peek before the called party answers the call.
Network-selected ring tone (e.g. top 5 randomly selected, or from a jukebox) to ring on the called party's device for each incoming call. These ring tones can be music, audible, voice, jokes, videos, multimedia display etc.
Network-stored but calling party selected (e.g. a one-time music gift or a pre-configured selection) to ring on the called party's device for each incoming call. These ring tones can be music, audible, voice, jokes, videos, multimedia display etc.
Network-stored but called party selected (e.g. a one-time music gift or a pre-configured selection) to ring on the calling party's device for each incoming call, These ring tones can be music, audible, voice, jokes, videos, multimedia display etc.
Incoming email headers since last notification to flash on the calling party before the call is answered and/or on the called party's device for each incoming call. The email-accounts selected will be based on the subscription preferences of the subscribers.
Funny audibles (e.g. “this is Tony Blair, u have a weapon of mass destruction in your pocket, bang”, “order, order, will the right honorable gentleman please pick up the phone”) to play on the called party's device for each incoming call.
Real-time news channel (e.g. text news, or TV news) to flash on the calling party before the call is answered and/or on the called party's device for each incoming call. The particular news channel selected will be based on the subscriptions of the subscribers.
Real-time sports update (e.g. tennis, golf, NBA, soccer etc) to flash on the calling party before the call is answered and/or on the called party's device for each incoming call. The particular sports update selected will be based on the subscriptions of the subscribers. They can even be video/TV highlights of scoring moments.
Real-time weather updates to flash on the calling party before the call is answered and/or on the called party's device for each incoming call. The particular weather update selected (e.g. home area, visiting country etc) will be based on the subscriptions of the subscribers.
Multiple channels of information updates to flash on the calling party before the call is answered and/or on the called party's device for each incoming call. For example, the called party can subscribe to news flash, email headers, weather, stock quotes etc flashing thru the screen while the incoming call is ringing.
Quote or word of the day to flash on the calling party before the call is answered and/or on the called party's device for each incoming call. For example, the called party can subscribe to a quote of wisdom (e.g. “I don't fear God but I fear who God fears”, “If you criticize someone, try to wear his shoe and walk about 100 meters from the person so that when you do criticize the person, you are 100 m away and you have his shoe”) flashing thru the screen while the incoming call is ringing.
Advertisement for the calling party or called party or both to subsidize this call. Called party subscription can in particular save money for receiving calls when roaming abroad.
Information about calls related to his other devices. For example, if a subscriber has two devices, one left home (or lost) and one is with him. He might want to be notified of the information of the calls made to his device left at home. He might also want to be notified of the information of the calls made by the device left at home. This shows that push content can be sent to a third party.
Information about calls related to some devices by parental control or police control. For example, the parent (father and mother) might want to be notified calls made by or made to his kids. This shows that push content can be sent to a third or fourth party. In the case of police control, all police officers involved can get notified of calls made by or made to a suspect under surveillance.

In an embodiment, the call setup triggered push content service is a subscription-based service for the mobile operators. The push content service includes different push contents and multiple services of the same push content. For example, a subscriber may subscribe to either or both a calling party received service and a called party received service. Both the calling party and the called party may be subscribers of their respective services for a call. While paying monthly subscription, any change in the subscribed push content or the subscribed push content service may lead to a different charging to the subscribers. This further increases the mobile operator's revenue.

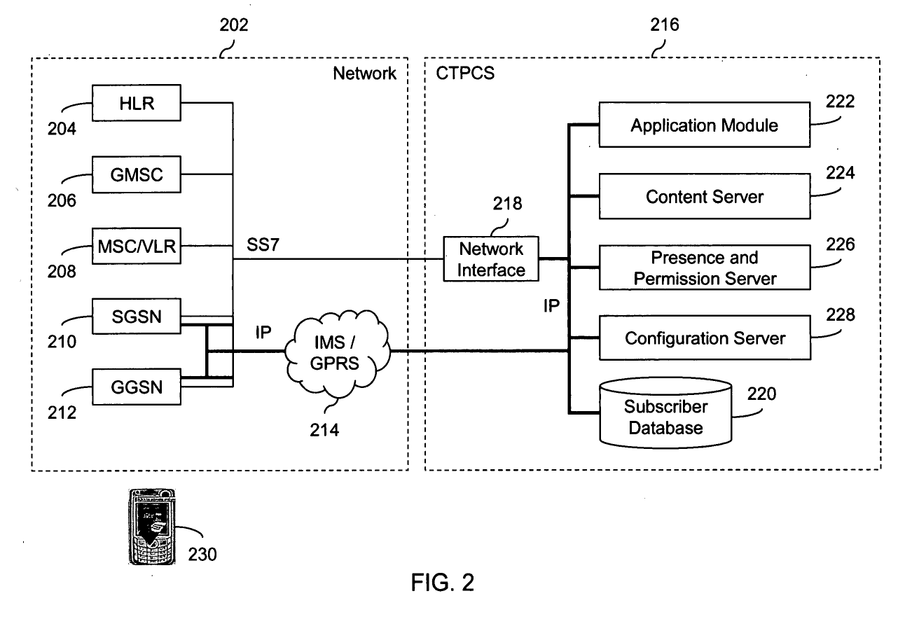

FIG. 2 is a block diagram depicting a system for providing call setup triggered push content to at least one receiving party (not shown) in the telecommunications network, in accordance with an embodiment of the present invention. In various embodiments, the receiving party may be the calling party, the called party, and/or one or more third parties.

The figure shows a network 202, which is a call-based network. In other words, network 202 provides for calls between its users. In the embodiment depicted in the figure, network 202 is a General Packet Radio Service (GPRS) enabled GSM network. Network 202 includes a Home Location Register (HLR)/Home Subscriber System (HSS) (hereinafter collectively referred to as HLR) 204, a Gateway Mobile Switching Center (GMSC)/Call Session Control Function (CSCF) (hereinafter collectively GMSC) 206, Mobile Switching Center (MSC)/Visited Location Register (VLR) (hereinafter collectively referred to as MSC) 208, Service GPRS Support Node (SGSN) 210, and Gateway GPRS Support Node (GGSN) 212. Further, network 202 uses an IP Multimedia System (IMS)/GPRS network 214. The functioning and interoperation of these elements in a GSM/GPRS network is well known in the art.

The figure also shows a call-triggered push content system (CTPCS) 216 comprising a network interface 218, a subscriber database 220, an application module 222, and a content server 224. CTPCS 216 further optionally includes a presence and permission (PnP) server 226, and a configuration server 228. CTPCS 216 interfaces with network 202 through network interface 218 and IMS/GPRS network 214.

Further, the figure shows a device 230. Device 230 is connected with network 202, and is subscribed to CTPCS 216. Device 230 has a client software (hereinafter referred to as ‘client’) loaded on it, which enables device 230 to receive, present or render, and upload push content. In the context of the present invention, presenting push content on a device includes, but is not limited to, playing audio content, playing video content, and displaying text content on the screen of device 230. In various embodiments, the client may be configured to read out text content. In an embodiment, the client further enables management of subscriber preferences and permissions, maintenance of presence information of a subscriber, or both. The function of the client is described in detail later in the document.

Network interface 218 interfaces CTPCS 216 with network 202. Further, network interface 218 performs a call control function. The call control function can be similar to the that of a Signal/Service Control Point (SCP) or Service Node which allows a switch to suspend the call and request instructions (such as connecting the call to another number, monitoring call answer events etc) from the call control function. Network interface 218 interfaces with network 202 via Signaling System 7 (SS7) protocol and/or Internet Protocol (IP). In various embodiments of the present invention, network 202 is configured to pass the call control, along with at least one call parameter, to network interface 218.

In an embodiment, HLR 204 stores the CTPCS subscriber's trigger profile. The CTPCS subscriber is a subscriber who has subscribed to services offered by the CTPCS. The trigger profile is downloaded to MSC 208 at which the subscriber's device is registered. On originating call setup, MSC 208, or CSCF in IP Multimedia Subsystem (IMS), passes the call control to network interface 218 for further instruction. In another embodiment, HLR 204 passes the subscriber's trigger profile to GMSC 206 at terminating call setup, to pass the call control to network interface 218 for further instruction.

The call parameters pass to network interface 218 and include details of the call. In an embodiment, the call parameters can include, but are not limited to, an application identifier, a calling party number, a calling party International Mobile Subscriber Identity (IMSI), a called party number, a Visited Mobile Switching Center (VMSC) location.

In an embodiment, subscriber database 220 stores subscriber profiles including, by way of non-limiting example, job change, marital status change, and recent activities (e.g. just came back from Tibet). In an embodiment, subscriber database 220 stores the preference settings of the subscribers. The profile and preference settings may include, for example, the push content details of the subscriber, the identity of a calling party, the identity of a called party, a third party identity, call history information, time of the day, season, and relationships. In an embodiment, subscriber database 220 stores locations of call parties, historical information, and timing information of call parties. Historical information includes without limitation, one or more of, voice usage of the subscriber, data usage of the subscriber, frequency of calls to/from the subscriber, number of calls to/from the subscriber, missed calls in an interval, subscription history, information usage profile (e.g. loves music), set up history on the device, and/or download history. Timing information includes the time of the call, season, and the time zone of the subscriber. Call party location information includes the home country of the subscriber, the current location of the subscriber, and the current location of the call parties.

Further, in an embodiment, subscriber database 220 stores the service subscription profile for each subscriber that includes, without limitation, the channel of subscriptions of the subscriber, and the plan level of the subscriber.

Application module 222 applies application logic based upon the call parameters and/or the preference settings. More specifically, application module 222 determines the parties to whom content must be pushed in response to a call setup request, or the receiving parties. Further, application module 222 identifies the content to be pushed to these receiving parties, in response to the call setup request. When network interface 218 receives call control for a call setup request, it interfaces with and provides the call parameters to application module 222.

Application module 222 can be configured to generate such instruction by applying rules and logic based on the application for which the push content infrastructure is used. It would be apparent to one skilled in the art that a wide range of rules and logic may be applied by application module 222 without deviating from the sprit and scope of the present invention. Some examples of such rules and logic are described hereinafter to illustrate certain aspects of the present invention, and should not be considered limiting.

An example of application logic for push content relates to the application of ring tone forwarding. For example, the called party may subscribe to a ring tone jukebox for ringing on his/her device for an incoming call. Application module 222 may be configured, for example, to select a different tone from a network accessible jukebox for each incoming call. In another example, the called party may subscribe to a calling party defined push ring tone for ringing on his/her device, where the calling party has selected/uploaded a push ring tone.

In another example, application module 222 may select a more “urgent sounding” ring tone (with a higher pitch and/or volume) if the calling party has called the called party for more than a pre-defined number of times without getting an answer. The pre-defined number may be a configured by the subscriber or by the operator of network 202. In another example, application module 222 may select a different ring tone if the calling party has called the called party more than a pre-defined number of times within a configurable period.

Another example of application logic for push content relates to sharing of user profiles. Application module 222 may push the user profile of the calling party to the called party, and vice versa, before call setup. In an embodiment, if the calling party has been pushed with the called party profile in a previous call between them, and there is no change in the user profile of the called party since the last push, then no profile will be pushed.

Another example of application logic for push content relates to pushing other user information to the device, such as new email alerts, stock alerts, general news alerts, customized news alerts such as sports news, and country-specific news. For example, if the called party has received new emails and has subscribed to the email notification channel from CTPCS 216, then the email sender and subject of each new email may be pushed to the called party's device to be presented before, during and/or after the incoming call. In another example, if the called party has subscribed a stock data channel from CTPCS 216, then each stock data of his/her interest may be pushed to the called party's device for presentation before, during, and/or after an incoming call.

Other such channels that may be made available to subscribers of CTPCS 216 include, without limitation, a sports highlights channel (providing TV/video-based push content, or just a multimedia message), a country specific news channel (where the country of interest may be preconfigured, or determined at the time of the call based on the current location of the subscriber), and a location specific weather channel (where the location of interest may be preconfigured, or determined at the time of the call based on the current location of the subscriber).

Further, push content may include text, audio, video, and or multimedia advertisements. In an embodiment, the revenue generated from the advertisements may be used to finance the call.

Another example of the rules and logic applied by application module 222 includes determining if a ring tone needs to be pushed to a receiving party. For example, the calling party (or the calling party's network operator) may have selected a push ring tone for the called party, and the called party may have subscribed to a push ring tone service. In this case, if the called party device is already configured to ring the push ring tone for an incoming call from the calling party, then application module 222 decides not to push the ring tone to the called party.

In another embodiment, a subscriber of CTPCS 216 may subscribe to the service of new phone software upgrades. In this case, subscriber database 220 stores information about the software downloads made by the subscriber. At the time of call setup, application module 222 can determine if the software on the subscriber's device is up to date, using information from subscriber database 220. If the last downloaded version of software on a subscriber's device is not up to date, application module 222 may decide to push the latest version of the software to the subscriber's device.

In an embodiment, no content is pushed to the receiving party if the receiving party is determined to be roaming, thus avoiding roaming charges.

PnP server 226 stores presence and permission related data of the subscribers. In an embodiment, PnP server 226 is responsible for the presence and availability of a client on the called party's device. Specifically, PnP server 226 maintains the presence status (for example, online, offline, silent mode, busy, and temporarily away) of each subscriber. In an embodiment, if the called party is busy on another call, the client informs PnP server 226.

In another embodiment, PnP server 226 wakes the client with a Wireless Application Protocol (WAP)-push Uniform Resource Locator (URL), or a Short Message Service (SMS) URL for the client to establish an IP connection and passes the IP address of the client to PnP server 226. In this embodiment, PnP server 226 may use a direct SS7 connection to send the SMS to the device rather than going thru a SMSC to reduce latency. The direct SS7 connection may use a protocol for example, Mobile Application Part—Send Routing Information-Send Message (MAP-SRI-SM) followed by a Mobile Application Part—Forward SMS (MAP ForwardSMS).

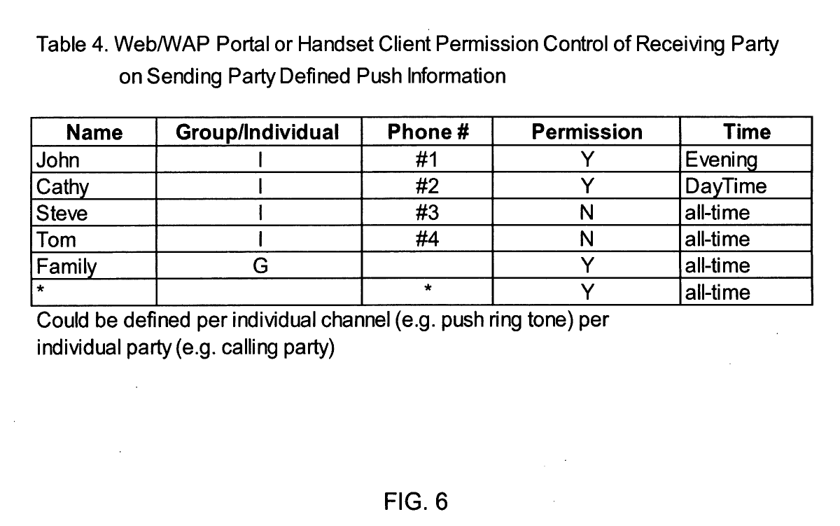

Further, PnP server 226 can also be responsible for server-side management of the Push Information (e.g. ring forward tone) permissions granted by the called party. In an embodiment, the called party uses the client on the device to configure the permission of the push information (e.g. ring forward tone service). This can be defined as a whitelist and blacklist. A whitelist is a list of callers who are permitted to push content to the called party. A blacklist is a list of callers who are not permitted to push content to the called party. For unknown callers and/or private callers, default permission can be configured. One such default permission for the application of ring forward tone, for example, could be to play the ring tone of device's ordinary configuration. Another default permission for ring forward tone is to grant permission to push content, thereby increasing the surprise and excitement factor. A schema for a client-user interface on the receiving party for granting call party defined ring tone permissions is described in detail with reference to FIG. 6.

The permission preferences of a client are uploaded to PnP server 226. In an embodiment, application module 222 uses permission preferences from PnP server 226 to determine the receiving parties of push content. It is advantageous to apply the permission preferences at CTPCS 216 instead of applying them at the device the since the caller ID might be lost when the call is delivered to the device. For example, when determining whether a calling party's defined ring forward tone should be pushed to the called party or not, the PnP server 226, which is on the network side, can use the calling party ID to check for conformance with permissions defined at PnP server 226.

In another embodiment, out-of-band communication between PnP server 226 on the network side and the client on the device side can also be used to deliver Caller ID to outbound roamers. The out-of-band communication uses a separate data bearer and voice bearer for call setup.

Application module 222 uses the presence and permission data stored in PnP server 226 for its application logic. Application module 222 could apply, for example, the logic that if a receiving party is in a switched-off mode or silent mode, no content is pushed to the receiving party.

Once application module 222 has identified the receiving parties and the content to be pushed to them, it issues a request to content server 224 to deliver the push content accordingly. Content server 224 maintains and delivers the push content to the receiving parties. In an embodiment, content server 224 comprises a push content database for maintaining the push content. In an embodiment, the push content database may comprise a network jukebox. In an embodiment, content server 224 downloads the push content to a receiving party device. In another embodiment of the present invention, the push content is streamed to the receiving party device. Further, depending on receiving party device capability and application logic, the push content may be transferred to the receiving party device before the call answered, during the call, or after completion of the call.

The content can be pushed to receiving parties that may include, for example, the calling party, the called party, or both. In an embodiment, the content may be pushed to a group of parties, allowing the subscriber to make a call to generate push content and send it to a group of recipients. The content can be any channel of multimedia data including, but not limited to, ring tones, video tones, real-time mobile television (TV), video-casts, sport highlights and scores, jokes, audible, pictures, flash texts, a quote of the day, multimedia, news, weather, email summary, stocks, voice message callers, Over-The-Air (OTA) configuration (for example, MMS or GPRS settings, WAP settings, Push To Talk Setting, Instant Messaging Presence Setting etc), software updates, and games.

In an embodiment, the push content can be provided by a network operator, a content operator, or a service operator. Further, a single operator may provide the network infrastructure, push content, and services.

In another embodiment, the push content is provided or created by subscribers who upload the content to content server 224. Subscriber created content (for example music, or an audible) can be published for other subscribers to use, optionally after an administrative vetting by the content operator. In an embodiment, each download of a published subscriber created content adds an increment of value to the creator's credit. The value credited may be money, or other measures of value such as redeemable bonus points.

The upload of the subscriber's provided or created content can be at the time of call setup for at least the current one-time usage, or done prior to call set up for possible future usage many times. The current one-time usage will also be recorded for future usage as well.

Configuration server 228 allows configuration of the receiving party subscription and the preference settings. In an embodiment, configuration server 228 allows configuration of the sending party subscriptions and preference settings. Configuration server 228 allows for such configuration through one or more configuration interfaces. Configuration interfaces may be, for example, a Wireless Application Protocol (WAP) interface, or a Web interface.

In an embodiment, a subscriber of CTPCS 216 can use the web interface of configuration server 228, or customer care, to specify subscriber's device model. In response, configuration server 228 sends a WAP-push, or SMS URL, or MMS alert with URL (for example, pointing to the client software) to the subscriber's device. The URL enables the subscriber to retrieve the content (for example, the client software) of the URL, where the content may optionally include a downloadable installer of the client. If the subscriber does not know the exact device model, configuration server 228 can send a SMS URL to the device to see if the device client can retrieve the URL. In an embodiment, if the device can retrieve the URL, the device profile is sent via user agent profile to content server. The delivery of the SMS URL, or WAP-push URL, or MMS alert with URL is advantageously done via direct SS7 SMS delivery, rather than through the Short Message Service Center (SMSC). The direct SS7 delivery can go through network interface 218 as well.

The function of device client is described hereinafter. In an embodiment, the push content receiving party (calling or called party or third party) needs to have a client installed on its device 230 for using the service of CTPCS 216. The client is not required if the push information can be supported by standard device features (for example SMS, WAP-push etc). In various embodiments, the non-receiving party (calling or called or third party) need not have the client on their device 230. However, if the non-receiving party also has the client, it can push pre-selected content, or content selected during call setup, to the receiving party. For example, the calling party can send an item (such as a ring tone, music, an audible, an MMS, and/or other multimedia) during a call. Conversely, the called party can also send an item when receiving a call. Further, it is convenient for a subscriber with a client to set subscription preferences and permission control in interaction with CTPCS 216. It is therefore advantageous to have the client installed on the devices 230 of both the receiving parties and the non-receiving parties.

In an embodiment, the client is built-in on open phone system on Smart Phone devices such as Symbian, Java/J2ME phone, Window Mobile phone, BREW phone, Palm and Trio phone etc. Therefore, the client can be used without changing device 230. In an embodiment, the client may be downloaded over the air to a Smart phone device from content server 224. It can also be downloaded from a PC connection to device 320, or from another client equipped device 320 via Bluetooth, infrared, WiFi, or any other connection. Further, the operator may choose to charge for each download/transfer of the client, or offered the client free of charge.

In an embodiment, the client includes a streaming client that can play content in streamed multimedia formats. Further, the client handles call control functions to present the pushed content (via streaming or using downloaded file) upon receiving an incoming call.

In an embodiment, the client operates in two modes: a download-first mode, and a streaming mode. In one embodiment, the selection of the mode of operation is made based on the bearer service of network 202 (for example, 3G), and the capability of device 230. In the download-first mode, the client downloads the pushed information (for example, a ring forward tone) before presenting the information on device 230 (for example, playing or ringing). In the streaming mode, the client presents the push content as it is streamed from, for example, content server 224. Additionally, in the streaming mode, the client can also be configured to record/file streamed media as it is being played.

The operator can make access to the push content a subscription based service or a one-time paying service. The regulation of access to the push content may be done using Digital Rights Management (DRM) control. For example, the recorded/filed content may be restricted to not play offline, unless there is a DRM associated with it. In various embodiments, the DRM restricts the presentation of the pushed content to a pre-defined number of times. For example, the DRM may allow only a one-time play of ring tone. In this case, playing of the ring tone is restricted to one-time, irrespective of whether it was delivered to device 230 in the streaming mode or the download-first mode. In an embodiment, the subscriber may purchase a ring tone to store it locally for incoming call configuration. This generates further revenue for the operator.

Any push content stored locally by the client can be played offline (e.g. news, TV) in idle mode, or online in connected mode (e.g. inserting audibles or music in the middle of a conversation to create a rich talk experience), or in call setup mode (e.g. when the information is already on the device, there is no need to push).

The ability of the client to insert content (e.g. audibles, music, jokes etc) in the middle of a conversation enhances the user experience, and potentially increases call duration. Therefore, it may be viewed as a powerful revenue generating service for an operator.

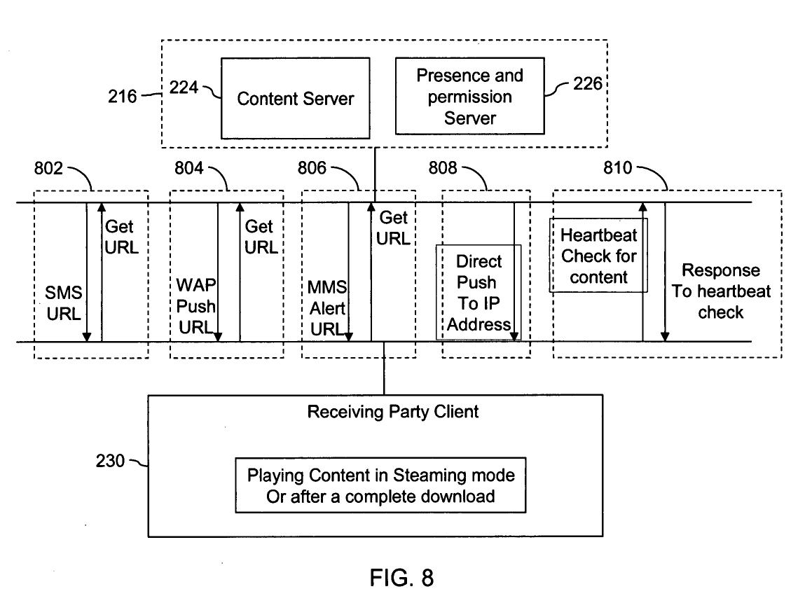

In various embodiments, the client is equipped with a presence capability to alert the PnP server 226 of availability status of device 230. In addition, the client informs PnP server 226 whether device 230 is already engaged in a call or not. In an embodiment, the client has a listening server capability that listens for pushed content (e.g. ring forward tone), or a request URL for it to start retrieving content in download-first mode or steaming mode. Various options of supporting push content delivery to device 230 are depicted in FIG. 8.

The client may be implemented as, for example, a Java, C++, Java 2 Platform Micro Edition (J2ME), and/or BREW application on an open platform, depending on the capability of device 230. The open platform may be Symbian, Windows-Mobile/PocketPC, Palm/Trio, BlackBerry or Linux. Device 230 may be a Session Initiation Protocol (SIP) phone or and IP Multimedia System (IMS) phone, and may be a fixed phone or a mobile phone.

In an embodiment, the client can be developed through Original Equipment Manufacturer (OEM) license relationships with manufacturers of device 230. In another embodiment, the client may be installed on any proprietary devices, in a manner analogous to Push-To-Talk clients, and Text-input (for example, T9) clients. The operator or service provider can offer the download of these clients over the air, or web, or PC.

In an embodiment, the operator may couple the client with some other client functionalities such as Push-To-Talk clients, VoIP (for example, Skype, Vonage Softphone, or any SIP apparatus) clients and/or Instant Messaging (IM) clients.

It will be apparent to one skilled in the art that the basic architecture of CTPCS 216 is substantially independent of the type of network it interfaces with. Therefore, CTPCS 216 may be used in conjunction with a range of networks, with different capabilities. CTPCS 216 can function in an in-band mode and an out-of-band mode. In the in-band mode, the call setup and the push content are integrated in the same bearer. In the out-of-band mode a separate voice channel and data channel may be coordinated to perform call setup and to delivery push content respectively.

If device 230 supports simultaneous voice and data, then push content can be streamed or downloaded during the call.

In an embodiment, if device 230 supports an all IP network (for example, an IMS/SIP network infrastructure), both voice and push content can be carried and played on the same IP bearer channel.

One commonly available type of device 230 is a Smart Phone device, often termed as a class B terminal in GSM GPRS parlance. Many class B terminals support only simultaneous voice and data attachment, and do not support simultaneous voice and data transmission. However, while one medium is transmitting on a class B device, the signaling for either medium can happen simultaneously. In the context of the present invention, this means that while the pushed content is downloading or streaming to the client, an incoming call can come in without interrupting the downloading/streaming and playing. However as soon as the call is answered, the data (e.g. GPRS) session need be suspended for such a class B terminal.

Thus, in an embodiment of the present invention, for a caller defined ring forward tone, while the push ring tone is being streamed or downloaded, an incoming call can trigger the client to play the push ring tone in streaming mode. When the call is answered, the client can suspend the streaming or downloading. Such streaming of a push content introduces negligible latency in call setup, since network interface 218 does not need to suspend the call for the download duration of the push content.

In another embodiment, device 230 may not support simultaneous signaling and streaming/downloading. In this case, the network interface 218 will need to hold the call until the push content is completely downloaded to device 230. Once the client acknowledges the download completion, the call setup may be allowed to continue. This embodiment may generate significant latency to call setup, particularly if the pushed information is large. However, in this embodiment, it is assured that the pushed content can be presented by the client as soon as it detects an incoming call.

In an embodiment, the CTPCS 216 has a dedicated access point name (APN) for the IP bearer channel used for pushing content. In another embodiment, CTPCS 216 can share an APN with other data services (e.g. MMS, email, WAP etc).

Further, in an embodiment, the operator may waive the local packet charge for traffic to and from CTPCS 216, and just charge a flat fee or monthly subscription fee for subscription to CTPCS 216.

It would be apparent to one skilled in the art that the principles and teachings of the present invention can be applied in conjunction with various networks such as a Code Division Multiple Access (CDMA) network, a Personal Digital Cellular (PDC) network, a Personal Handyphone System (PHS) network, an Institute of Electrical and Electronics Engineers (IEEE) 802.11 (WiFi) network, or an IEEE 802.16 (WiMax) network. Particularly, the present invention can be extended to work with any communication network that has the notion of a call (or any other attention-catching event) from one user of the network to another, and allows pushing of content to the users.

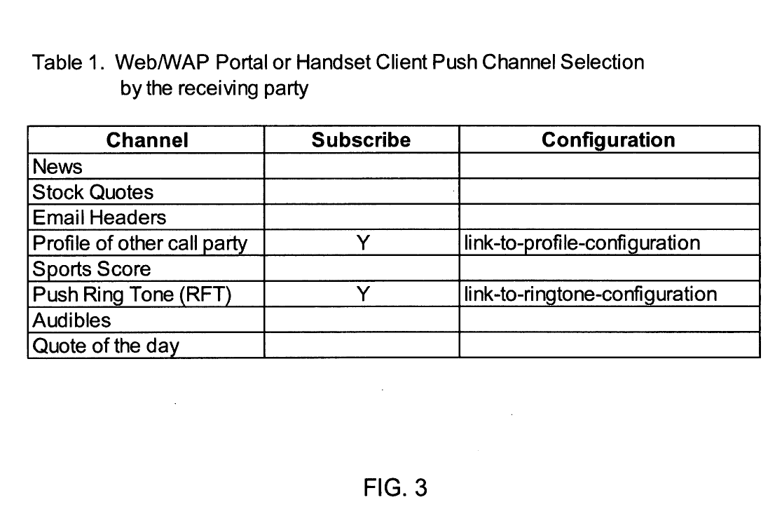

FIG. 3 shows a database table depicting an exemplary subscription profile for a receiving party, in accordance with an embodiment of the present invention. The database table contains a ‘Channel’ column that lists the push channels available to the receiving party. The receiving party can select multiple channels of push content from among these available channels, to receive push content from the selected channels. A ‘Subscribe’ column marks the selection of channels for the receiving party. In the table shown in the figure, the receiving party has selected to receive the profile of the other call party (calling party or called party or third party), and ring forward tones. Other available channels listed in the ‘Channel’ column include a news channel, a stock quotes channel, an email headers channel, a sports score channel, an audibles channel, and a quote of the day channel.

In an embodiment of the present invention, application module 222 uses a different selected channel depending on factors such as the time of a call, to determine the content to be pushed to the receiving party before the call. In another embodiment, application module 222 randomly chooses a selected channel to determine the push content for pushing to the receiving party before the call.

In various embodiments, the receiving party's subscription and the preference setting can be made through the web interface or the WAP interface of configuration server 228. Alternatively, these settings can be made through the client on the receiving party's device, which in turn interacts with configuration server 228. Subscriber database 220 stores the subscription profile and preference settings.

The database table further has a ‘Configuration’ column, which stores links to the appropriate configurations for the selected push channels.

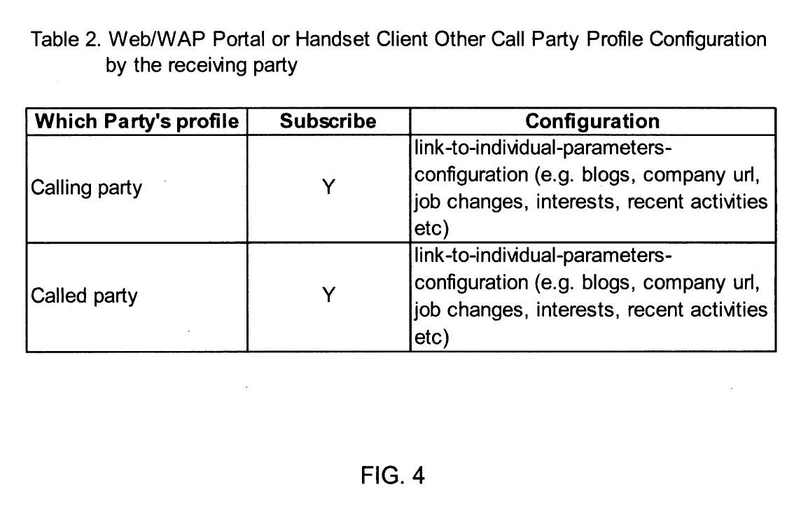

FIG. 4 shows the configuration of the profile channel for a receiving party. A ‘Which party's profile’ column lists the call parties whose profile may be delivered as push content, namely a calling party and a called party. The receiving party has indicated a ‘Y’ against both calling party and called party, in a ‘Subscribe’ column. Thus, the receiving party has chosen to receive the other party's profile both as a calling party and as a called party. The exact party profile parameters, for example job change, marital status change, recent activities (e.g. just came back from Tibet) of interest to the receiving party can be stored as a part of another configuration in subscriber database 220 through configuration server 228 and/or the client. A ‘Configuration’ column stores link to such further configuration details, if necessary.

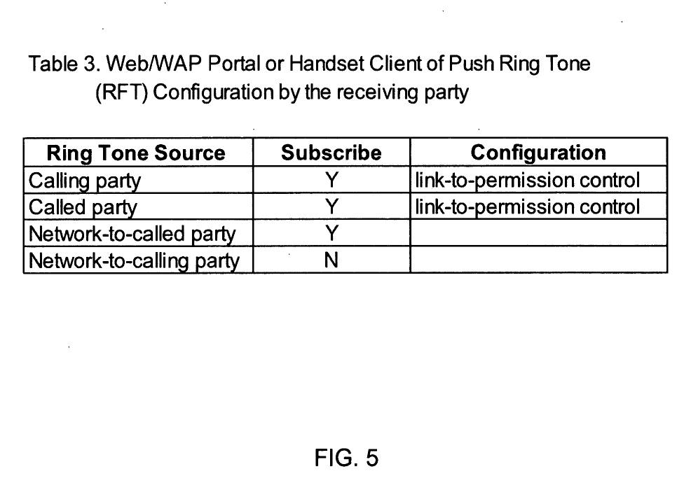

FIG. 5 shows an exemplary configuration of a ring forward tone (RFT) channel by a receiving party, in accordance with an embodiment of the present invention. A ‘Ring Tone Source’ column lists possible sources of ring tones, namely the calling party, the called party, and the network. The network may deliver ring tones to the receiving party when the receiving party is the called party or the calling party. These two cases are represented in the column as “network-to-called-party” and “network-to-calling-party” respectively. The figure shows that the receiving party wants the other party defined ring tone to ring on subscriber's device both as a calling party and as a called party. In addition, subscriber also subscribed to network defined ring tone to ring on his device when subscriber's device is a called party.

It will be apparent to one skilled in the art that for the present invention, the receiving party of CTPCS 216 of an operator must be a subscriber of the operator, while the non-receiving subscriber of CTPCS 216 of an operator does not have to be a subscriber of the operator. For example, if John as a normal mobile subscriber of CTPCS 216 of operator 1 subscribes to a caller defined ring forward tone service, a caller does not have to be a subscriber of the operator 1. The caller can just go to the web interface/WAP interface of configuration server 228 to configure his preference of a caller defined ring tone to ring on receiving devices that subscribe to CTPCS 216 of operator 1. In this way, each time the caller calls a subscriber of CTPCS 216 of operator 1; his defined ring tone can/may ring on the called party's device (depending upon other application logic).

In various embodiments, application module 222 decides the receiving parties based on the presence and permission information from PnP server 226. For example, pushing/forwarding of content can be restricted to presence mode, that is, when the receiving party is present/available online. Further, permissions for the push content can be defined by the receiving party when the push content is defined by the non-receiving party.

FIG. 6 shows an example of a general push content permission control by a receiving party against a sending party. The table shows permission control settings for a plurality of sending parties listed in a ‘Name’ column. The sending parties include four individuals (John, Cathy, Steve, and Tom), one group (Family), and a default setting (denoted in the figure by an asterisk). The table stores the phone numbers of each of the four individuals in a ‘Phone #’ column. Further, the table stores a permission setting for each of the users in a ‘Permission’ column. Last, the table stores the time at which the permission setting should be applied, under a ‘Time’ column.

For example, in the figure, the first entry in the table specifies that sending party “John”, having phone number as “#1” is permitted to send push content to the receiving party in “Evening” time.

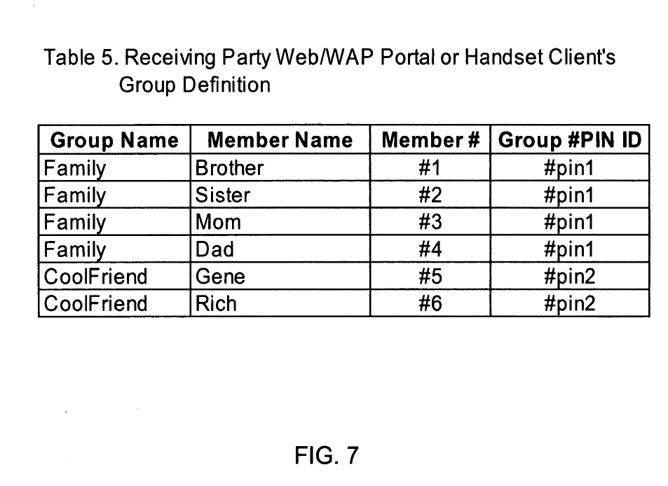

FIG. 7 shows a table containing group definitions of a subscriber of CTPCS 216. The table shows two groups defined by the subscriber, “Family” and “CoolFriend”. Group “Family” contains members “Brother”, “Sister”, “Mom”, and “Dad”. Similarly, Group “CoolFriend” contains members “Gene” and “Rich”. Each member's phone number is stored in column ‘Member #’. Further, each group has an associated group pin number, stored under a ‘Group # PIN ID’ column.

In an embodiment, such group definitions may be used to define push content permissions as shown with reference to FIG. 6. In another embodiment, these definitions allow the subscriber to use a single call setup to push information (e.g. new job, marriage invitation, new home address) to a group via a two step process. The first step is to call an operator's designated group number (e.g. a 800-number so caller ID can be captured). The second step is to enter the group PIN for the captured caller ID. Application module 222 controls the selection of content and delivery to individual members of the group.

The client allows the receiving party (calling or called or third party) to configure or keep the downloaded push content. In an embodiment, the receiving party pays a fee for this facility, for example for downloaded ringtones or music. The configuration or storage information can be sent to the network side under consideration by the application logic as part of its information parameters.

Downloaded information (push content) can also be used to trigger further download (e.g. more details after the call). For example, detailed, full MP3 music, any news not watched or read completely can be further downloaded after the call.

Downloaded information (e.g. ring tone) might have an identification (e.g. caller ID) which must be matched with the call number (e.g. incoming caller ID if the receiving device is the called party or called number if the receiving device is the calling party) for the receiving device to accept to perform some actions (e.g. playing the ring tone).

The downloading process can be streaming-based or completely downloaded first.

The download process can be stopped after the call is answered, or still continues depending on the device type/capability or can resume after the call is finished if suspended during the call.

Downloading can be push first and then pull when pushed information are URL, WAP push, MMS, SIP data URL etc.

FIG. 8 depicts various options of supporting push content delivery to device 230 from CTPCS 216. The figure shows an SMS URL option 802, a WAP URL option 804, and an MMS Alert URL option 806 to deliver push content.

In SMS URL option 802, CTPCS 216 sends device 230 a URL via SMS. In response, device 230 downloads the push content from the URL. Similarly, in WAP URL option 804 and MMS Alert URL option 806, CTPCS 216 sends device 230 a URL via WAP and MMS Alert respectively.

Further, the figure shows a direct push to IP address option 808, where CTPCS 216 directly pushes the push content to device 230. The push content is addressed to device 230 using the IP address of device 230. This option can be used if device 230 is connected and present with an IP address that can be seen by CTPCS 216.

In various embodiments, CTPCS 216 can not see the IP address of device 230 (for instance, due to security reasons). In this case, the client on device 230 may send a heartbeat signal to PnP server 226 and content server 224. PnP server 226 updates the presence status of device 230 in response to the heartbeat signal. Further, content server 224 checks if there is any content to be taken back by/downloaded to the client on device 230. In this manner, various embodiments of the present invention may be deployed on network architectures where the IP address of device 230 can not be seen by CTPCS 216.

In an embodiment, the client on device 230 keeps an always-on IP connection with network 202. In another embodiment, the client on device 230 is woken up by an SMS trigger (with request URL) to establish an IP connection and streaming/download push content. The former approach is quicker, since establishing an IP connection can take up to a dozen seconds in many conventional networks.

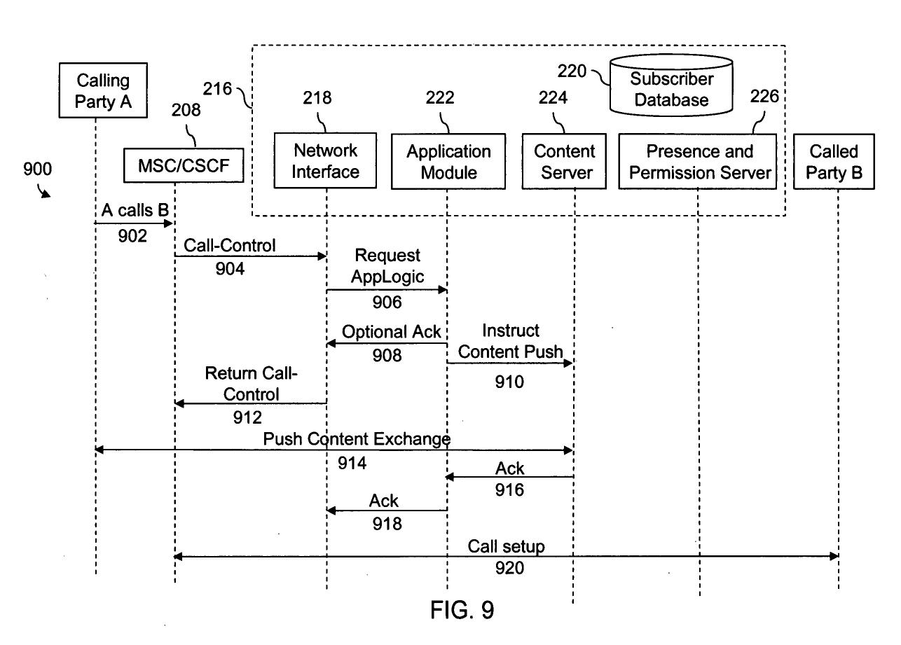

FIG. 9 illustrates an exemplary call flow 900 based on an originating party call control. At 902, a calling party A calls a called party B. Thus, with reference to the figure, calling party A is the originating party. MSC (or Call Session Control Function-CSCF) 208 of the calling party operator, receives the call. At 904, MSC 208 (or CSCF) 208 passes the control of the call to network interface 218 of CTPCS 216. The call control is passed with at least one call parameter. In an embodiment, the call control parameters include, but are not limited to, an application identifier (also called an AppKey), calling party A number, calling party A IMSI, Called party B number, and the VMSC location of calling party A. At 906, network interface 218 requests application module 222 to apply application logic by passing the call parameters obtained from network interface 218. Application module 222 applies the application logic in accordance with the call parameters. In an embodiment, if the application logic determines that there is no need for the call control to wait for the delivery of the push content, application module 222 sends an acknowledgement back to network interface 218 at 908. Application module 222 determines whether the application identifier corresponds to the application identifier of the calling party or the called party or both and also determines the corresponding push content details of the at least one receiving party (for example, calling party or the called party or both). At 910, application module 222 sends the push content details of the at least one receiving party to content server 224 to deliver the push content. At 912, network interface 218 returns the call control to MSC (or CSCF) 208. In an embodiment, network interface 218 may have an associated and configurable timer that when expires returns the call control to MSC 208. In an embodiment, network interface 218 optionally tracks some call events (e.g. call connected/answered, busy etc). At 914, content server 224 establishes push content exchange with calling party A. Then at 916, content server 224 sends an acknowledgement to application module 222 indicating that the request to push content according to the details specified at 910 has been processed.

In an embodiment, at 918, application module 222 applies accounting logic to produce a Call Detail Record (CDR) and returns an acknowledgement to the network interface 218. Network interface 218 may pass the call control back to the MSC (or CSCF) 208 at either the first acknowledgement from the application module 222 or the second acknowledgement from the application module 222 depending on for example, whether application module 222 has determined to pass the call control to MSC (or CSCF) 208 immediately or after the push content is delivered or about to be delivered to the receiving party. At 920, MSC 208 continues the call setup between calling party A and called party B. Further, the push content is played on the device of calling party A before the call is answered.

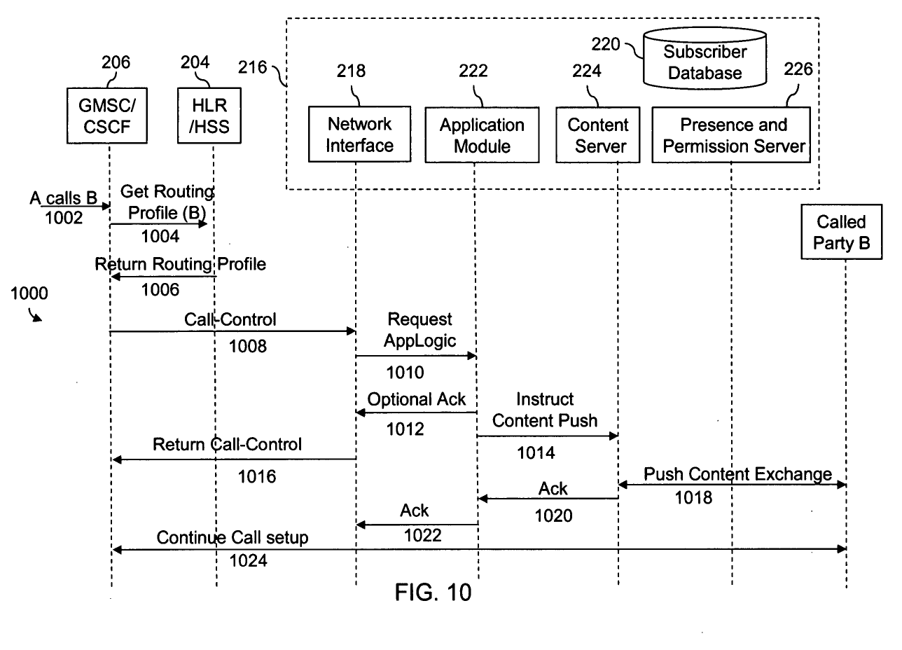

FIG. 10 illustrates an exemplary call flow 1000 based on a terminating party call control. At 1002, a calling party A calls a called party B, and GMSC (or Call Session Control Function—CSCF) 206 of the called party operator, receives the call. At 1004, GMSC 206 requests the subscription routing profile of called party B from the HLR (or Home Subscriber System—HSS) 204 of the called party operator. At 1006, HLR 204 returns the subscription routing profile of called party B, for example a call control trigger profile, to GMSC (or CSCF) 206. At 1008, GMSC 206 (or CSCF) passes the control of the call to network interface 218 of CTPCS 216 of the called party operator. The call control is passed with at least one call parameter. In an embodiment, the call control parameters include, but are not limited to, an application identifier (also called an AppKey), calling party A number, calling party A IMSI, Called party B number, and the VMSC location of calling party A. At 1010, network interface 218 requests application module 222 to apply application logic by passing the call parameters obtained from network interface 218. Application module 222 applies the application logic in accordance with the call parameters. In an embodiment, application module 222 optionally sends an acknowledgement back to network interface 218 at 1012. Application module 222 determines whether the application identifier corresponds to the application identifier of the calling party or the called party or both and also determines the corresponding push content details of the at least one receiving party (for example, calling party or the called party or both). At 1014, application module 222 sends the push content details of the at least one receiving party to content server 224 to deliver the push content. At 1016, network interface 218 returns the call control to GMSC (or CSCF) 206 depending upon for example, whether the call control is returned by the above optional acknowledgement or whether the application logic determines to wait for the push content to be delivered or not to the receiving party. In an embodiment, network interface 218 optionally tracks some call events (for example, call connected/answered, busy, etc) from the telecommunication network for further control or for billing purpose. At 1018, content server 224 establishes push content exchange with called party B. Then, at 1020, content server 224 sends an acknowledgement to application module 222 indicating that the request to push content according to the details specified at 1014 has been processed.

In an embodiment, at 1022, application module 222 applies accounting logic to produce a Call Detail Record (CDR) and returns an acknowledgement to network interface 218. Network interface 218 may pass the call control back to the GMSC (or CSCF) 206 at either the first acknowledgement from the application module 222 or the second acknowledgement from the application module 222 depending on for example, the application logic determining whether to wait for the push content to be delivered or not. At 1024, GMSC (or CSCF) 206 continues the call setup between calling party A and called party B. Further, the push content is played on the device of the receiving party (e.g. the called party B in this Figure) before the call is answered.

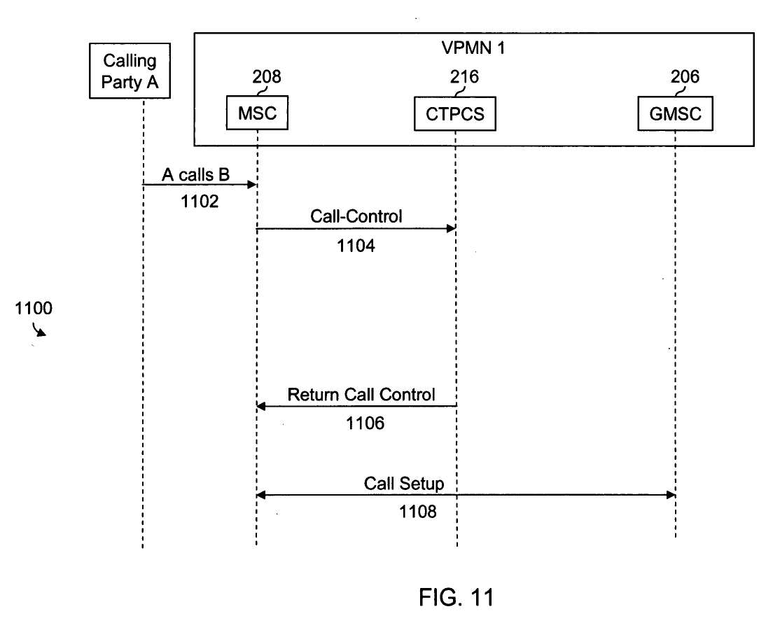

FIG. 11 illustrates the signal flow 1100 of the interaction between a calling party A, a called party B and CTPCS 216 while pushing content to the called party in accordance with an embodiment of the present invention. At 1102, a calling party A calls a called party B. MSC (or CSCF) 208 of the calling party operator, receives the call. At 1104, MSC (or CSCF) 208 passes the control of the call to CTPCS 216. The call control is passed with at least one call parameter. In an embodiment, the call control parameters include, but are not limited to, an application identifier (also called an AppKey), calling party A number, calling party A IMSI, Called party B number, and the VMSC location of calling party A. CTPCS 216 applies the application logic identified by the application identifier provided by CTPCS 216. CTPCS 216 determines whether the application identifier corresponds to the application identifier of the calling party and also determines if the called party is subscribed to receive the push content. It also determines whether the called party is also subscribed to the same operator as the calling party. At 1106, CTPCS 216 returns call control to MSC (or CSCF) 208 after optionally tracking some call events (e.g. call connected/answered, busy etc). At 1108, MSC (or CSCF) 208 continues the call setup. The terminating control of the called party at GMSC (or CSCF) 206 handles the push content service as explained in FIG. 10.

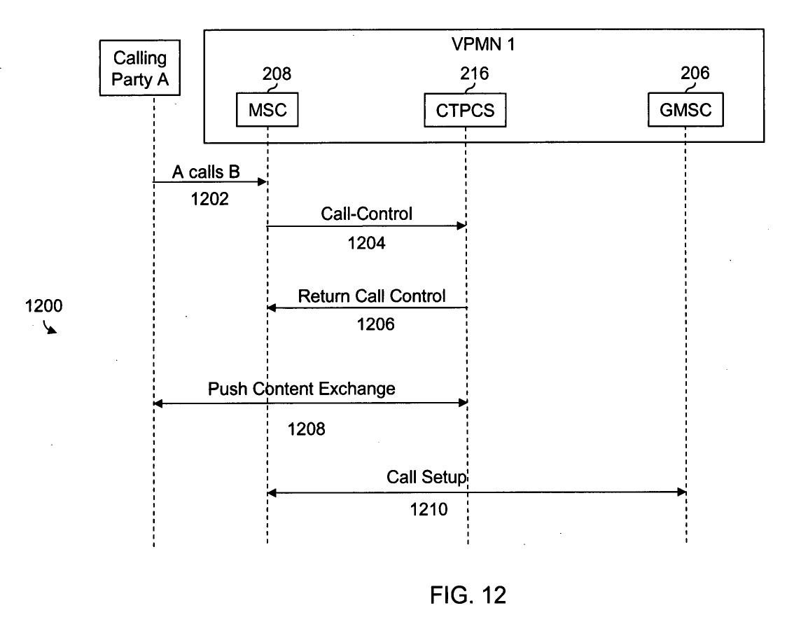

FIG. 12 illustrates the signal flow 1200 of the interaction between a calling party A, a called party B and CTPCS 216 while pushing content to calling party A in accordance with an embodiment of the present invention. At 1202, a calling party A calls a called party B. MSC (or CSCF) 208 of the calling party operator, receives the call. At 1204, MSC (or CSCF) 208 passes the control of the call to CTPCS 216. The call control is passed with at least one call parameter. In an embodiment, the call control parameters include, but are not limited to, an application identifier (also called an AppKey), calling party A number, calling party A IMSI, Called party B number, and the VMSC location of calling party A. CTPCS 216 applies the application logic identified by the application identifier provided by CTPCS 216. CTPCS 216 determines whether the application identifier corresponds to the application identifier of the calling party and also determines if the called party is subscribed to receive the push content. It also determines whether called party B is from the same operator. At 1206, CTPCS 216 returns call control to MSC 208 after optionally tracking some call events (e.g. call connected/answered, busy etc). At 1208, CTPCS 216 establishes push content exchange with calling party A and applies accounting logic to produce a CDR. At 1210, MSC (or CSCF) 208 continues the call setup with GMSC 206. The terminating control of the called party at GMSC (or CSCF) 206 handles the push content service as explained in FIG. 11.

Embodiments of the present invention also provide for inter-working of call setup push content services between a plurality of operators. These embodiments are described hereinafter. The description assumes that the operators involved use different mobile networks, namely a first Visited Public Mobile Network (VPMN-1) and a second Visited Public Mobile Network (VPMN-2), and have established inter-working relationship for call setup triggered push content services.

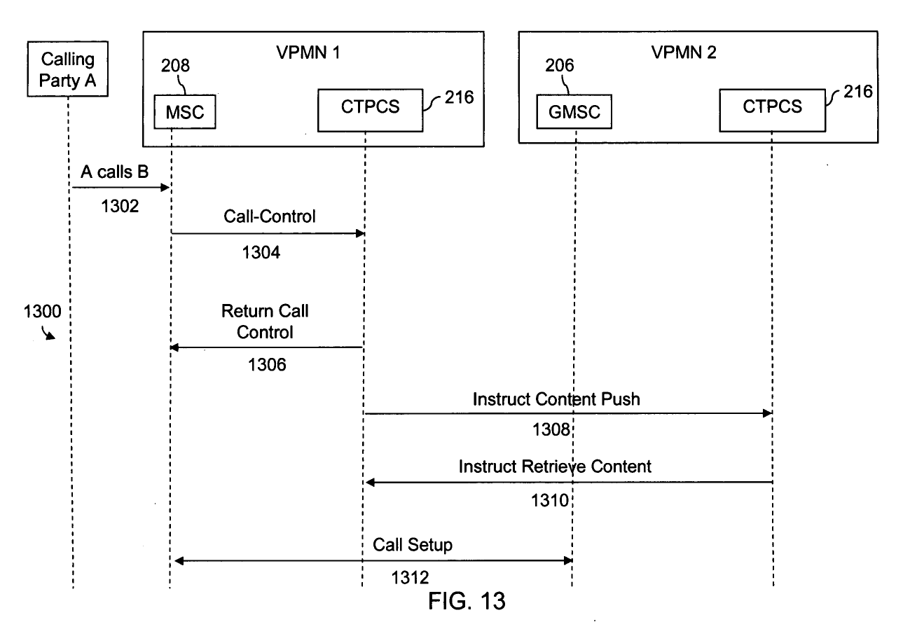

FIG. 13 illustrates an exemplary signal flow 1300 depicting inter-working of call setup triggered push content service between operators for a pushed content to the called party of VPMN-2. At 1302, a calling party A calls a called party B. Calling party A is present in a first Visited Public Mobile Network (VPMN-1) while called party B is present in a second Visited Public Mobile Network (VPMN-2). MSC (or CSCF) 208 of VPMN-1 receives the call. At 1304, MSC (or CSCF) 208 of VPMN-1 passes the control of the call to CTPCS 216 of VPMN-1. The call control is passed with at least one call parameter. In an embodiment, the call control parameters include, but are not limited to, an application identifier (also called an AppKey), calling party A number, calling party A IMSI, Called party B number, and the VMSC location of calling party A. CTPCS 216 applies the application logic identified by the application identifier provided by CTPCS 216. CTPCS 216 determines whether the application identifier corresponds to the application identifier of the calling party and also determines if the called party is subscribed to receive the push content. It also determines whether the called party is from the same operator. At 1306, CTPCS 216 of VPMN-1 returns call control to MSC (or CSCF) 208 of VPMN-1 after optionally tracking some events (e.g. call connected/answered, busy etc).

At 1308, CTPCS 216 of the VPMN-1 sends an InterOperatorSend-ContentPush command to CTPCS 216 of the VPMN-2. The InterOperatorSend-ContentPush command includes calling party A details, called party B details, and a content link. At 1310, CTPCS 216 of the VPMN-2 issues an InterOperatorRetrieveContent command to CTPCS 216 of the VPMN-1. CTPCS 216 of the VPMN-2 produces the CDR for called party B, while CTPCS 216 of the VPMN-1 produces the CDR for calling party A. CTPCS 216 of the VPMN-1 passes the call control back to MSC/CSCF of the VPMN-1 while the MSC/CSCF of the VPMN-1 continues the call setup.

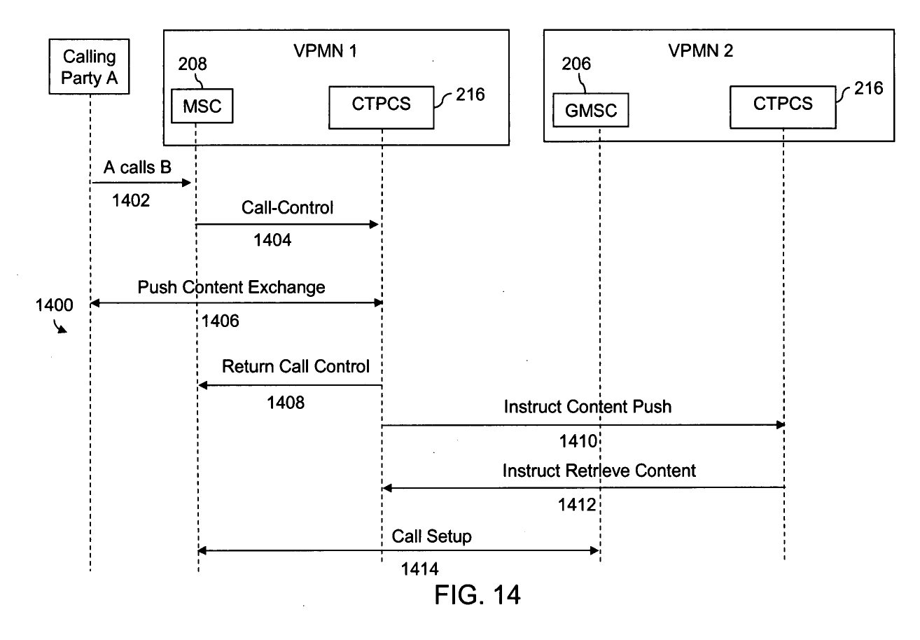

FIG. 14 illustrates an exemplary signal flow 1400 depicting inter-working of call setup triggered push content service between operators for a pushed content to the called party of VPMN-2 and the calling party. At 1402, a calling party A calls a called party B. Calling party A is present in a first Visited Public Mobile Network (VPMN-1) while called party B is present in a second Visited Public Mobile Network (VPMN-2). MSC (or CSCF) 208 of VPMN-1 receives the call. At 1404, MSC (or CSCF) 208 of VPMN-1 passes the control of the call to CTPCS 216 of VPMN-1. The call control is passed with at least one call parameter. In an embodiment, the call control parameters include, but are not limited to, an application identifier (also called an AppKey), calling party A number, calling party A IMSI, Called party B number, and the VMSC location of calling party A. CTPCS 216 applies the application logic identified by the application identifier provided by CTPCS 216. CTPCS 216 determines whether the application identifier corresponds to the application identifier of the calling party and also determines if the called party is subscribed to receive the push content. It also determines whether called party B is from the same operator. At 1406, CTPCS 216 sets up a push content exchange with calling party A. At 1408, CTPCS 216 of VPMN-1 returns call control to MSC (or CSCF) 208 of VPMN-1 after optionally tracking some call events (e.g. call connected/answered, busy etc).

At 1410, CTPCS 216 of the VPMN-1 sends an InterOperatorSend-ContentPush command to CTPCS 216 of the VPMN-2. The InterOperatorSend-ContentPush command includes calling party A details, called party B details, and a content link. At 1412, CTPCS 216 of the VPMN-2 issues an InterOperatorRetrieveContent command to CTPCS 216 of the VPMN-1. CTPCS 216 of the VPMN-2 produces the CDR for called party B, while CTPCS 216 of the VPMN-1 produces the CDR for calling party A. CTPCS 216 of the VPMN-1 passes the call control back to MSC/CSCF of the VPMN-1 while the GMSC/CSCF of the VPMN-1 continues the call setup.

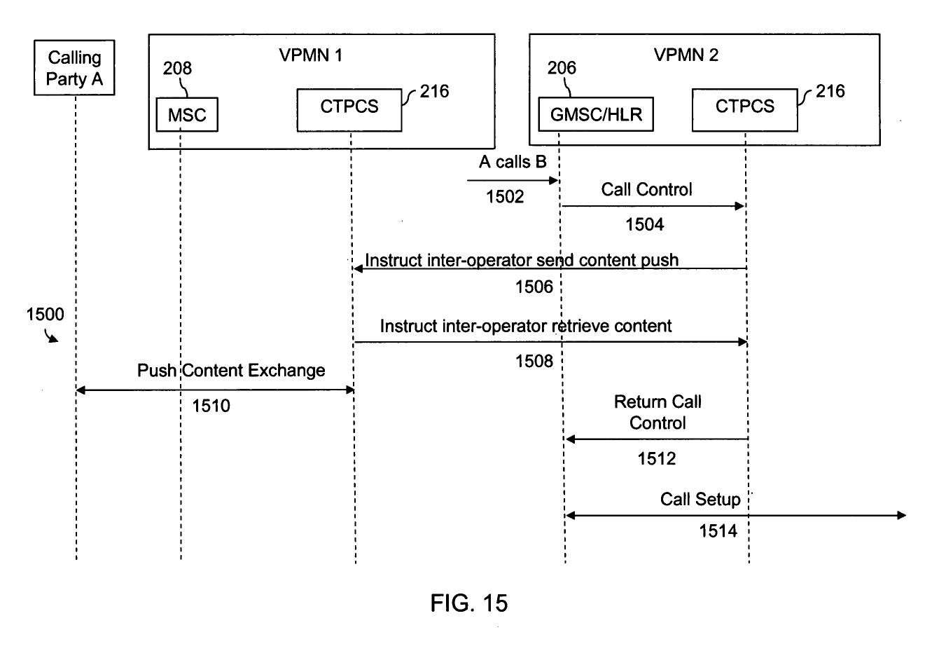

FIG. 15 depicts the inter-working of CTPCS 216 of VPMN-1 and CTPCS 216 of VPMN-2 where the defined content from called party B of VPMN-2 is being pushed to calling party A of VPMN-1. At 1502, calling party A of VPMN-1 calls called party B of VPMN-2. The call proceeds to VPMN-2 and reaches GMSC (or CSCF) 206 of VPMN-2. GMSC (or CSCF) 206 of VPMN-2 interacts with HLR 204 of VPMN-2 to obtain call details such as the VMSC and IMSI of called party B. Further, at 1504, GMSC (or CSCF) 206 of VPMN-2 passes the call control to CTPCS 216 of VPMN-2 with call parameters including, but not limited to, an application identifier (also called an AppKey), calling party A number, Called party B number, Called party B IMSI, and the VMSC location of called party B. CTPCS 216 of VPMN-2 applies application logic of AppKey on the call parameters and data from subscriber database 220. It determines that called party B has defined push content for the calling party A of VPMN-1. Further, CTPCS 216 of VPMN-2 may push content to called party B (not shown) depending on the application logic. CTPCS 216 of VPMN-2 identifies the push content defined by called party B for calling party A.

At 1506, CTPCS 216 of VPMN-2 sends an InterOperatorSend-ContentPush command to CTPCS 216 of VPMN-1. At 1508, CTPCS 216 of VPMN-1 returns an InterOperatorRetrieveContent command to CTPCS 216 of VPMN-2. At this stage, CTPCS 216 of VPMN-1 produces a CDR for calling party A and VPMN-2 for inter-working charge, and CTPCS 216 of VPMN-2 produces CDR for called party B.

At 1510, CTPCS 216 of VPMN-1 establishes a push content exchange operation with the calling party A. CTPCS 216 of VPMN-1 produces another CDR for calling party A. At 1512, CTPCS 216 of VPMN-2 passes the call control back to GMSC (or CSCF) 206 of VPMN-2. At 1514, GMSC (or CSCF) 206 of VPMN-2 continues the call setup.

In various embodiments of the present invention, the call control is passed from a telecommunication network infrastructure to CTPCS 216. Therefore, in the description of the above figures, sometimes the network interface optionally sends an acknowledgment back (i.e. returning the call control) to the telecommunication network to continue the call setup. The call control may be returned to the telecommunication network infrastructure at a time that is determined by, but not limiting to, at least one of the following events: (i) after the push content has started (ii) after the push content is completed (iii) after a configurable duration has passed since start of push content (iv) for stream-able push content, after a URL is downloaded. The aforementioned events may also depend upon push content channel and type. The telecommunication network infrastructure timers may also be reset using IN/CAP controls to provide for a longer return of call control.

Some applications enabled by the system and method of the present invention are now described. Specifically, the application of the principles of the present invention to ring tone forwarding (or Ring Forward Tone (RFT)), news flash service, and call party profile service are described. Ring tone forwarding relates to delivering a call party (e.g. calling or called or third party) defined ring-tone to another (or same) call party (e.g. calling or called or third party). A specific instance of ring forward tone service is to deliver calling party defined ring tone to the called party. News flash service relates to providing push content containing news updates. Call party profile service deals with pushing profiles of the calling party or called party, or portions thereof, at the time of call setup.

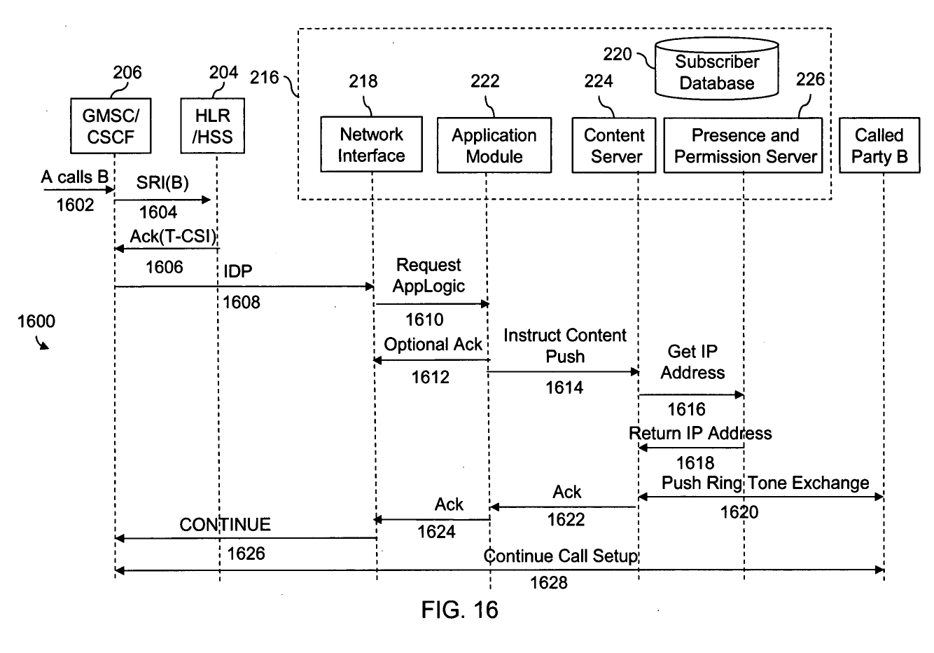

The application of ring tone forwarding is described hereinafter with reference to FIGS. 16, 17, and 18. The figures illustrate three examples of ring tone forwarding applications. The first example is based on called party call control for delivering calling party defined ring tones to the called party. The second example is based on calling party call control for delivering called party defined ring tones to the calling party. The third example demonstrates inter-working between operators where a calling party of VPMN-1 is calling a called party of operator VPMN 2 with a calling party defined ring tone that is subscribed by the called party.

The RFT service includes ring tone download service, personalized (color) ring back tone service, and personalized Ring Forward Tone (RFT) service. The present invention allows a subscriber of the ring tone download service to download more colorful polyphonic musical ring tones onto his device so that the musical ring tone may ring on the device when the subscriber receives a call. In this scenario, the operator of the subscriber from both bearer (e.g. GPRS) and the billing service along with the service provider and the content provider may generate revenue from the service.

In the personalized (color) ring back tone service, the present invention allows the subscriber to set colorful music as ring back tone for callers. The operator of the subscriber may generate revenue in a number of ways including, but not limited to, subscription, each change of a ring back tone and the billing service. Further, the service provider and the content provider may also generate revenue. Further, the subscriber may define the ring back tone he would prefer to hear when he calling a called party.

In the personalized Ring Forward Tone (RFT) service, the present invention allows the subscriber to dictate the colorful ring tone (audio, music, video, multimedia etc) he wishes to be played on the called party's device as long as the called party grants such permission. The operator may generate revenue from for example, the subscription of the calling/called party and bearer services of one call party on receiving the dictated music ring tone from the other call party. The operator may further generate revenue from each change of a musical ring tone by a call party (for example, calling party/called party). Further, the ring forward tone may also be defined by a call party (calling or called) subscriber for the other call party (called or calling). Furthermore, the ring forward tone service may provide the called party or the calling party or both parties unexpected pleasant surprises. An operator or service provider may deploy one or more of the RFT services. Furthermore, these services can be deployed across operators.

The ring back tone service and the ring forward tone service may also help the operator and the content/service provider to publicize (for example, a viral marketing) the popular ring tones among the called parties and the calling parties. Unlike the ring back tone service which plays ring tone in the network side to the calling party, the ring forward tone service plays the ring tone at the called party's device side or the calling party's device side or both. As a result, the operator/service/content providers get revenue opportunities for example, when the receiving parties (called or calling or third party) of the ring forward tones decide to actually save or install the ring tone on the device after the first playing. In an embodiment, Digital Right Management (DRM) may help to facilitate the revenue generating process. In addition, the operator can make additional revenue when the subscribed call (calling or called) party chooses to pass the ring forward tone as a gift to the other call (called or calling) parties.

Unlike the traditional ring back tone service, the ring forward tone service however requires a client in the receiving party device. In an embodiment, the client may be a downloadable (for example, Symbian, Java, Linux, Window, Brew, etc) to the device. The client may control permission of the call parties allowed to dictate ring tone on the subscriber's device. The ring forward tone may be an identification of the caller/callee for example, by style or type of music or a particular music or seasonal greetings or special days (e.g. anniversary, birth day etc) or humor.

In an embodiment, the ring forward tone service also facilitates the calling party to hear a called party defined ring tone. For example, when A calls B, A could hear B's ring tone pushed to A's device as music, video, text, voice or jokes.

In another embodiment, a ring forward tone may be sent to both calling and called parties simultaneously. The ring forward tone for each receiving party may be network defined (e.g. from the jukebox) or defined by the receiving party (e.g. category of ring tone) or defined by the other call party in a call.

In an embodiment, the RFT client may have a turn on/off switch to allow the receiving (e.g. called or calling or third) party to temporary switch off the ring forward tone service and let his/her device take over the control of a ring tone without changing any calling party's permission. This might be helpful in avoiding embarrassing situations.

In an embodiment, the RFT client may detect if the receiving party device is in a silent mode or not and pass the information to the Presence and Permission server. The Presence and Permission Server in turn informs the content server either not to send a ring forward tone or send a URL for future retrieval if the ring forward tone is a gift from the calling party.

Additionally, the RFT client may allow the hosting party (e.g. called or calling) device to screen a changed ring forward tone or pre-verify it for the other call party (e.g. calling or called) before allowing the other call party to have the ring forward tone ringing on the receiving party's device for all future calls.

To solve the device critical mass issue, the operator may send WAP push or SMS to the subscribers with a URL to download the client and may also explain the RFT service. The subscription procedure of the RFT service of a mobile operator for a subscriber may also require registration of the subscriber using a web service or a customer care service. Once the subscriber provides the device information, the RFT service may send a WAP push or SMS URL to the device. The RFT service subscriber can then retrieve the URL to download the client to the device. The RFT service subscriber can also indicate who else can download such a client to the RFT service. The RFT service can track who has downloaded the client.

In an embodiment, each RFT service subscriber may need a permission to download the client to help build up the critical mass. The RFT service subscriber may have the added incentive to select, change and test ring forward tone any time. This may allow the subscriber to call the called party with one-time ring tone and to gift a ring tone to the called party. In one embodiment, the RFT service subscriber can also use the same client to select, change and test ring back tone. In another embodiment, the RFT subscriber can also use the same client to test, upload/record and download the ring tone or MP3 music. The RFT service subscriber may be charged for sending a RFT as a gift to the called party using the client.

Although ring back tone service is a purely network-based service that does not requires any device changes and works across networks, however, it is expensive to play ring back tone using voice circuit resources as sometimes the resources are tied up and the call is connected without switch changes. In contrast, the RFT service using data bearer to play the ring forward tone is a much more cheaper proposition. Furthermore, by installing a client on the device side, the RFT subscriber may avail any of the aforementioned services (e.g. select, change and test ring back tone, ring forward tone or just download ring tone/music etc). Also, it provides the operator further data revenue opportunities over the data bearer. Although the data bearer usage itself for RFT can be part of the flat fee structure of the data bearer, however the RFT subscription, the change of ring back tone and ring forward tone, the download of ring tone and other content provide additional value added data revenue beyond data bearer.

In an interesting statistics, it was noted that 65% of people currently use web to set ring back tone or download ring tone. This in a way hinders the growth of the ring tone market. With the RFT client on a device having the capability to select, test, change, set and download ring tone, ring back tone, ring forward tone etc, may help to speed up the ring tone market.

In an embodiment, if a RFT subscriber calls a called party device (or is being called by a calling party device) that does not have the RFT client, a free SMS URL can be sent to the called (or calling) device in the name of the sending party provided the sending party has given such permission which can be the default at the time of subscription. If the device supports web/WAP URL retrieval, the user agent profile is revealed to the content server for retrieving the right client (Symbian, Window Mobile or BREW etc) to the device.

Various embodiments of the ring forward tone service include, but not limited to, the following:

In one embodiment, the ring forward tone can be a music tone, a multi-media streaming, a MMS, a picture show, a video show, a personal announcement, a celebrity voice, humor recording, a signature music tone, and the like. In another embodiment, the RFT subscriber or call (calling or called) party can record their own personal video, music, picture show and MMS to be stored/uploaded in the network for streaming to the called party. In yet another embodiment, a RFT subscriber may specify a ring forward tone to be gifted to the calling/called party either via an IVR interface or by using the RFT client on the device or by using the dialing prefix/postfix to indicate the choice of the ring tone. Alternatively, the calling party can preset a ring forward tone as a part of subscription. In various embodiments, the calling party can also use a one-time trigger to select a ring forward tone by prefixing or postfixing the dialed number or a USSD command or a web interface or a IVR or WAP (etc) before the call to reserve a ring forward tone for next call.

In yet another embodiment, the RFT service may be deployed in an enterprise environment for a corporation. In this model, an enterprise can mandate its company employees during working hours to use company-oriented ring forward tones (e.g. promotion and ads) when the employees make or receive a call. The RFT service may be used by the enterprise for advertising purpose for either employee or general public. For example, the RFT service might involve playing a company designated music on the called parties of an employee during the office hours while at other times the employee may avail free ring forward tone service. Alternatively, the enterprise might promote its advertising by playing a short company music tone in front of a subscriber. In case the subscriber likes the RFT, the enterprise might offer/sponsor the ring forward tone service for free.

In an embodiment, since the receiving RFT subscriber device contains a client, it is possible for the subscriber to upload a musical ring tone at the content server for streaming the musical ring tone to the called party either at the time of the call or before the call is made. In an embodiment, the call (called or calling) party who receives a ring forward tone in a call can store, configure or purchase the RFT or subscribe the RFT to be heard by his called party using the client.

In an embodiment, the RFT service allows a subscriber to download a RFT when the RFT receiving party (called or calling or third) hears the ring tone ringing on the device. In another embodiment, the RFT service may be integrated with music download service such as iTune. Since a short term (e.g. 15 secs) ring tone snippet can act as a test run to entice the receiving party to download the actual MP3 music equivalent of the ring tone in one click. The RFT service essentially makes the device even a better tool for MP3 player because of the ease of trying out a snippet (from a ring forward tone) and the ease of downloading a MP3 music equivalent of the ring tone.

The ring forward tone service may be availed by wireless cellular operators and subscribers. Further it can be availed by the fixed line or internet operators (WiFi, WiMax, DSL, Cable modem etc), particularly in VoIP. The VoIP client can be SIP based (e.g. GIZMO) or operator-defined (e.g. Skype). For example, using Skype open API, a client that enables the calling party to dictate a ring forward tone that is sent out of band to the called party Skype client may be developed which can then stream in the incoming ring forward tone as a ring tone in addition to setting permissions to allow or disallow ring forward tone from certain callers. Using the Skype open API, a client that enables the calling party to receive a ring forward tone that is sent out of band from the called party Skpye client may be developed so that the calling Skype client can play the ring forward tone as a ring tone while waiting for the called party to answer.

The call (calling or called) party can subscribe to the RFT service via calling to IVR/Call-Center/Customer-care or internet/web as a subscriber of a fixed line operator (cable provider, RBOC etc). The call (calling or called) device can be any phone device for example, a VoIP device with the RFT client. The called party's device in the fixed line world, however, must be able to receive the ring forward tone. It must have the capability to install a special client on the device to play/stream the ring forward tone. The receiving party device has a packet data connection to receive the ring forward tone. The present invention supports IMS deployment strategies which integrate fixed line world with VoIP phone. The RFT service can be such an IMS service for these fixed line/wireless combo-operators.

In an embodiment, the RFT client may provide configuration options to grant personalized permissions to allow callers ring tone to ring on the receiving party devices when the receiving party devices receive calls from these callers. The client can be integrated with presence and permission information to enable the subscriber to control when to allow ring forward tone service from callers. The client can also maintain a constant IP connection/session so incoming calls' ring forward tones can be seamlessly streamed before they are answered.

When a call (calling or called) party subscribes to an RFT service, initially the subscriber can get a jukebox of ring forward tones like yahoo music subscription at a monthly fee X from the operator. When called, if the calling party does not define a ring forward tone allowed by the called party, the jukebox may send a ring forward tone to the subscribed called party, unless configured to be overwritten by the subscriber for that calling number. Similarly when calling, if the called party does not define a forward tone allowed by the calling party, the jukebox may send a ring forward tone to the subscribed calling party, unless configured to be overwritten by the subscriber for that called number.

Call (calling or called) party can use web, IVR etc. in the same way as RFT service to set RFT for all the other call parties (called or calling) and for one particular call (called or calling) party. In an embodiment, each selection of an RFT for a party (calling or called) may have a monthly charge and a one-time fee although both may be free. The receiving party has to be a subscriber of the operator allowing the RFT service. The other call party has to be the operator subscriber if charged; otherwise the other call party can be subscribed to any other operator (other mobile, fixed). Alternatively, in the charged model, the subscriber can get premium RFTs while the other operators (mobile or fixed line)'s subscribers can only freely set non-premium RFTs.

In the call setup triggered push content service however, it is possible to have the following different kinds of example push ring tone applications which we term as Ring Forward Tone because of its forwarding or push nature of the tone to a receiving device (whether it is to the called party or calling party or even third party) as triggered by a call setup and also because the ring tone plays like an incoming call ring tone or music even to the calling device (not via a voice bearer as in ring back tone where the tone is not heard by the calling party like an incoming call ring tone).

In an embodiment, the source of the ring tone ringing on a calling party device can be defined by the network, by the called party or by the calling party at the network. In an embodiment, the source of the ring tone ringing on a called party device can be defined by the network, by the calling party at the network or by the called party at the network.

The application of ring tone forwarding is described hereinafter with reference to FIGS. 16, 17, and 18. The figures illustrate three examples of ring tone forwarding applications. The first example is based on called party call control for delivering calling party defined ring tones to the called party. The second example is based on calling party call control for delivering called party defined ring tones to the calling party. The third example demonstrates inter-working between operators where a calling party of VPMN-1 is calling a called party of operator VPMN 2 with a calling party defined ring tone that is subscribed by the called party.

FIG. 16 illustrates a call flow 1600 depicting called party call control for delivering calling party defined ring tones to the called party in accordance with an embodiment of the present invention. The call flow described in the figure assumes that a called party B has installed the client on the device, and that calling party A has set up the ring forward tone for called party B's device.

At 1602, calling party A calls called party B. This call setup request reaches GMSC 206 of called party B. Note that for this example, calling party A does not have to be a subscriber of the operator of called party B. At 1604, GMSC 206 queries HLR 204 of called party B via Mobile Application Part (MAP) Send Routing Information (SRI) command, to get a call trigger profile. In response, at 1606, HLR 204 of called party B returns Terminating—CAMEL Subscription Information (T-CSI) for called party B to GMSC 206. At 1608, GMSC 206 passes the call control via Intelligent Network/CAMEL Application Part (IN/CAP) Initial Detection Point (IDP) to network interface 218 of CTPCS 216 of the called party network, with at least one call parameter. The call parameters may include, but are not limited to, an AppKey=RFT (indicating that the requested application is Ring Forward Tone), number of calling party A, number of called party B, IMSI of called party B, and the VMSC location of called party B. At 1610, network interface 218 requests application module 222 to apply the Ring Forward Tone application logic. Application module 222 uses the call parameters and data from subscriber database 220 to determine that a ring tone defined by calling party A needs to be pushed to called party B, where called party B is a subscriber of the calling party defined ring tone service. At 1612, application module 222 optionally sends an acknowledgement to network interface 218 depending upon whether it is set by the operator or whether the application module determines to wait for the delivery of the push content or not.

At 1614, application module 222 sends an instruction to content server 224 to push content. The instruction includes push content details which may include, but are not limited to, an indication of called party B as the recipient of the push content, and a ring tone content ID. At 1616, content server 224 requests presence and permission server 226 for Internet Protocol (IP) address information of called party B. At 1618, presence and permission server 226 returns the IP address of called party B to content server 224. At 1620, content server 224 establishes a push content exchange operation to deliver the ring tone to called party B. Further, at 1622, content server 224 sends an acknowledgement to application module 222. In turn, at 1624, application module 222 sends an acknowledgement to network interface 218.

Then, at 1626, network interface 218 issues an Intelligent Network (IN) CONTINUE command to GMSC 206. In another embodiment, network interface 218 issues the IN CONTINUE command to GMSC 206 in response to the first acknowledgement received from application module 222 after 1612. At 1628, GMSC 206 continues the normal call setup.

In an embodiment, the client at called party B starts to play the pushed ring tone right after receiving it, or in other words after 1620. In another embodiment, the client at called party B starts to play the pushed ring tone at the incoming call, or in other words after 1628. The client at called party B also interacts with a device call management menu to detect acceptance, rejection, or silencing of the call by called party B. Accordingly, the client will stop playing the ring tone if the called is accepted, rejected, or silenced.

A racing condition may occur if two simultaneous calls are received by called party B from different calling parties. In an embodiment, to avoid the racing condition, the client may check the Caller ID of the incoming call to match with the pending ring forward tone session to play, in case there are more than one ring forward tone sessions pending. Even though there is one ring forward tone session pending, it could be possible that another simultaneous call without a ring forward tone control can come in. Therefore, in case the caller ID for the simultaneous incoming calls is unknown, the client may have a default configuration to address such a case. For example, one default configuration could be that if there is a pending ring forward tone session, the client will play the ring forward tone, even though caller ID is unknown. It is also possible to have multiple ring forward tone sessions pending which can be selected based on caller ID of the incoming call. If caller ID of an incoming call is unknown, one default configuration may be include the client playing the first pending ring forward tone.

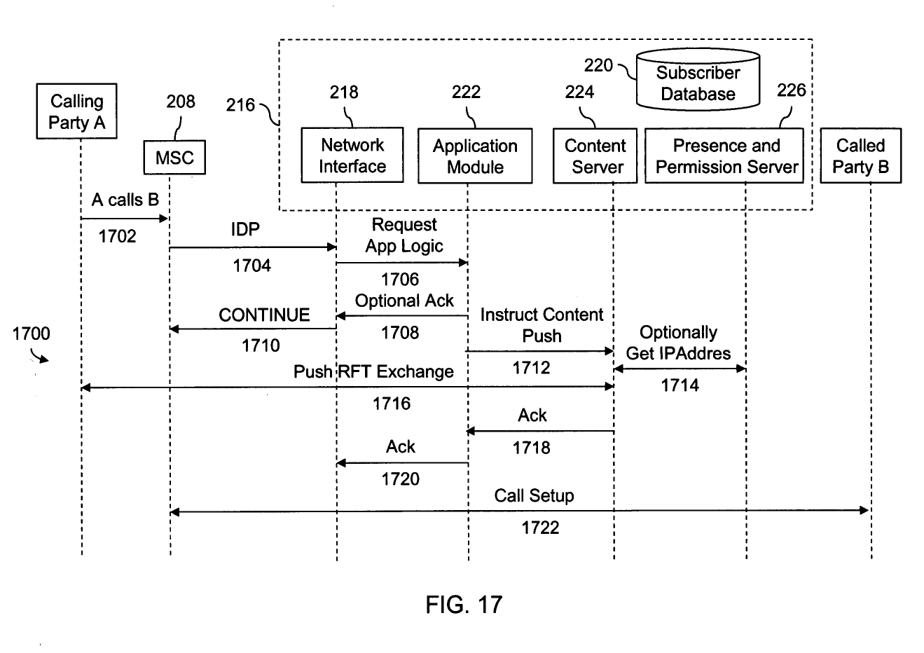

FIG. 17 illustrates a call flow 1700 depicting calling party call control for delivering a called party defined ring tone to the calling party in accordance with an embodiment of the present invention. The call flow assumes that calling party A has installed the client on the device, and that called party B has set up the ring forward tone for calling party's device.

At 1702, calling party A calls called party B and the call setup request reaches MSC 208. At 1704, MSC 208 passes the call control via IN/CAP IDP to network interface 218, with at least one call parameter. The call parameters may be, but are not limited to, an AppKey=RFT (indicating that the requested application is Ring Forward Tone), number of calling party A, IMSI of calling party A, number of called party B, and the VMSC location of calling party A. At 1706, network interface 218 requests application module 222 for applying application logic. Application module 222 uses the call parameters from network interface 218 and data from subscriber database 220 to determine that a ring tone define by called party B needs to be pushed to calling party A. At 1708, application module 222 may optionally send an acknowledgement to network interface 218 depending on whether the operator sets or the application module determines to wait for the delivery of the push content or not. Upon receiving this acknowledgement, at 1710, network interface 218 may issue an CONTINUE command to MSC 208.

At 1712, application module 222 instructs content server 224 to push content. The instruction includes push content details which may include, but are not limited to, an indication of calling party A as the recipient of the push content, and a ring tone content ID. At 1714, content server 224 optionally requests presence and permission server 226 for Internet Protocol (IP) address information of calling party A, and retrieves this information. At 1716, content server 224 establishes a push content exchange operation to deliver the ring tone to calling party A. Further, at 1718, content server 224 sends an acknowledgement to application module 222. In turn, at 1720, application module 222 generates a CDR and sends an acknowledgement to network interface 218.

In an embodiment, if network interface 218 had not issued an CONTINUE command to MSC 208 at 1710, it does so at this stage. Then at 1722, MSC 208 continues the normal call setup.

The client on the device of calling party A starts to play the pushed ring tone right away or when it receives an indication of the call ringing. The client also interacts with the device call management menu for accepting or rejecting the call. Upon accepting or rejecting, the client will stop playing the ring forward tone.

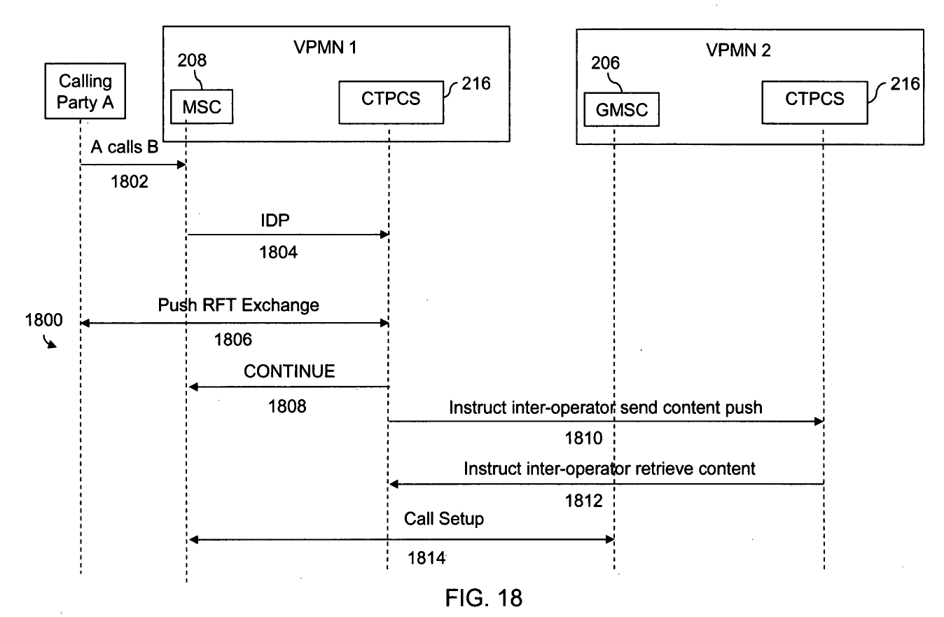

FIG. 18 illustrates a call flow 1800 depicting inter-working between operators where a calling party of VPMN-1 is calling a called party of operator VPMN-2 with a calling party defined ring tone that is subscribed by the called party in accordance with an embodiment of the present invention. The call flow assumes that calling party A has also set up the ring forward tone for the called party's device. At 1802, calling party A of VPMN-1 calls called party B of VPMN-2. The call setup request is received by MSC 208 of VPMN-1. At 1804, MSC 208 of VPMN-1 passes the call control via IN/CAP IDP command to CTPCS 216 of VPMN-1. The IDP command includes at least one call parameter. Call parameters may include, but are not limited to an AppKey=RFT (indicating that the requested application is Ring Forward Tone), number of calling party A, number of called party B, IMSI of called party B, and the VMSC location of called party B. CTPCS 216 of VPMN-1 uses the call parameters from MSC 208 of VPMN-1 and data from subscriber database 220 of VPMN-1 to determine that a ring tone defined by calling party A needs to be pushed to called party B, where called party B is a subscriber of calling party defined ring tone service and called party B is from VPMN-2. VPMN-2 has CTPCS 216, and a ring forward tone inter-working relationship with VPMN-1.

At 1806, CTPCS 216 of VPMN-1 sends the ring tone defined by calling party A for called party B to the CTPCS 216 of VPMN-1. CTPCS 216 of VPMN-1 acknowledges the receipt of the calling party defined ring tone and produces the CDR. CTPCS 216 of VPMN-1 produces the CDR and issues CONTINUE to MSC 208 of VPMN-1 at 1808. CTPCS 216 of VPMN-1 sends inter-operator send content push command to CTPCS 216 of VPMN-2 to facilitate inter-working between the operators at 1810. CTPCS 216 of VPMN-2 issues inter-operator retrieve content command and applies accounting logic to produce CDR of the called party at 1812. CTPCS 216 of VPMN-1 applies accounting logic to produce CDR of the calling party. The MSC 208 of VPMN-1 continues the call setup at 1814. The called party of VPMN-2 follows the terminating call control to eventually get the calling party defined ring tone pushed to his device for playing upon an incoming call or before the call the answered.

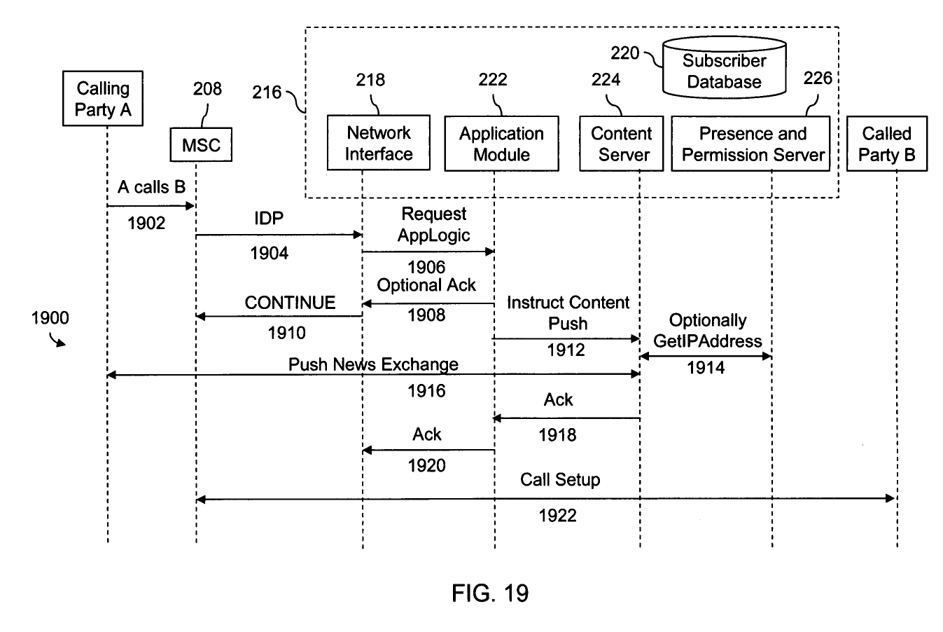

FIG. 19 describes the news flash service of the CTPCS with respect to a subscriber each time the subscriber makes a call in accordance with an embodiment of the present invention. The subscriber includes a calling party, a called party or any individual who has subscribed to the service. Although the embodiment describes the delivery of the news flash service when the subscriber makes a call, similar service may be defined when a subscriber receives a call. The news flash includes text, TV, video or multimedia content. In an embodiment, the signaling flow may be based on an originating IN. In another embodiment, the signaling flow may be based on O-CSI-like implementation.

At 1902, calling party A calls called party B. At 1904, MSC 208 passes the call control via IN IDP (CAP. INAP etc) command to network interface 218. The IDP command includes at least one call parameter. Call parameters may include, but are not limited to an AppKey=serviceKey (indicating that the requested application is news flash), number of calling party A, number of called party B, IMSI of calling party A, and the VMSC location of calling party A. The network interface 218 requests instruction from application module 222 by passing the call parameters at 1906.

The application module 222 applies the application logic identified by the serviceKey using the data from network interface 218 and subscriber database 220 and optionally sends an acknowledgement back to network interface 218 depending on for example, whether application module 222 determines to wait for the delivery of the push content or not at 1908. Upon receiving this acknowledgement, at 1910, network interface 218 may issue an IN CONTINUE command to MSC 208.

The application module 222 determines whether the calling party has subscribed to the news flash service. It also determines the calling party to push content to (in this example, application module 222 determines the calling party, however, in other embodiments the application module may determine the called party or both) and the news flash content ID and sends the push content details to content server 224 at 1912. Optionally, content server 224 may communicate with PnP 226 to obtain the IP address of the calling party for establishing push content exchange at 1914. The content server 224 establishes push content exchange with the calling party at 1916 in accordance with various embodiments described above. The content server 224 returns an acknowledgement to application module 222 at 1918, which in turn produces a CDR of the calling party by applying accounting logics. The application module 222 returns an acknowledgement to network interface 218 at 1920. The network interface 218 may pass the call control back to the MSC 208 using IN CONTINUE at either the first acknowledgement (1910) from application module 222 (for example, in streaming mode of push content) or the second acknowledgement from application module 222. The MSC 208 may continue the call setup at 1922. The calling party device client plays the news flash content before the call is answered.

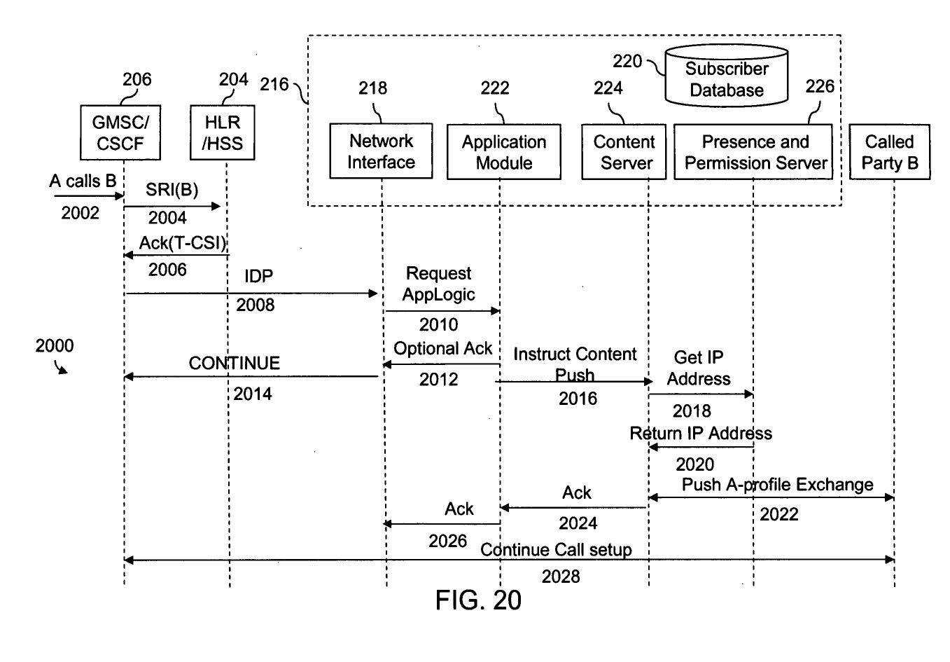

FIG. 20 illustrates profile information of a call party pushed to the other call party in either or both directions in accordance with an embodiment of the present invention. At 2002, calling party A calls called party B. The call reaches GMSC/CSCF 206 of the operator of the called party. The GMSC/CSCF 206 issues SendRoutingInformation SRI to HLR 204 of the called party at 2004. The HLR 204 returns IN/CAMEL trigger profile to GMSC/CSCF 206 at 2006. At 2008, GMSC/CSCF 206 passes the call control via IN IDP (CAP. INAP etc) command to network interface 218. The IDP command includes at least one call parameter. Call parameters may include, but are not limited to, an AppKey=serviceKey, number of calling party A, number of called party B, IMSI of called party B, and the VMSC location of called party B. The network interface 218 requests instruction from application module 222 by passing the call parameters at 2010.

The application module 222 applies the application logic identified by the serviceKey using the data from network interface 218 and subscriber database 220 and optionally sends an acknowledgement back to network interface 218 depending on for example, whether application module 222 determines to wait for the delivery of the push content or not at 2012. Upon receiving this acknowledgement, at 2014, network interface 218 may issue an IN CONTINUE command to GMSC/CSCF 206.

The application module 222 determines whether the called party has subscribed to the calling party profile service. It obtains the calling party A profile content ID which may be obtained by filtering both calling party A and called party B profiles. For example, calling party A might have blocked his marriage status from access by called party B while called party B might not wish to know calling party A's job status. The application module 222 determines the called party B to push content to (in this case, the called party, but it can also be calling party or both) and the calling party A profile content ID and sends them to content server 224 to push at 2016. Optionally, content server 224 may communicate with PnP 226 to obtain the IP address of the called party for establishing push content exchange at 2018. PnP 226 returns the IP address of the called party at 2020. The content server 224 establishes push calling party profile exchange with the called party at 2022 in accordance with various embodiments described above.

The content server 224 returns an acknowledgement to application module 222 at 2024, which in turn produces a CDR of the called party by applying accounting logics. The application module 222 returns an acknowledgement to network interface 218 at 2026. The network interface 218 may pass the call control back to GMSC/CSCF 206 using IN CONTINUE at either the first acknowledgement (2012) from application module 222 (for example, in streaming mode of push content) or the second acknowledgement from application module 222. The GMSC/CSCF 206 may continue the call setup at 2028. The called party device client plays the calling party profile before the call is answered or at the incoming call.

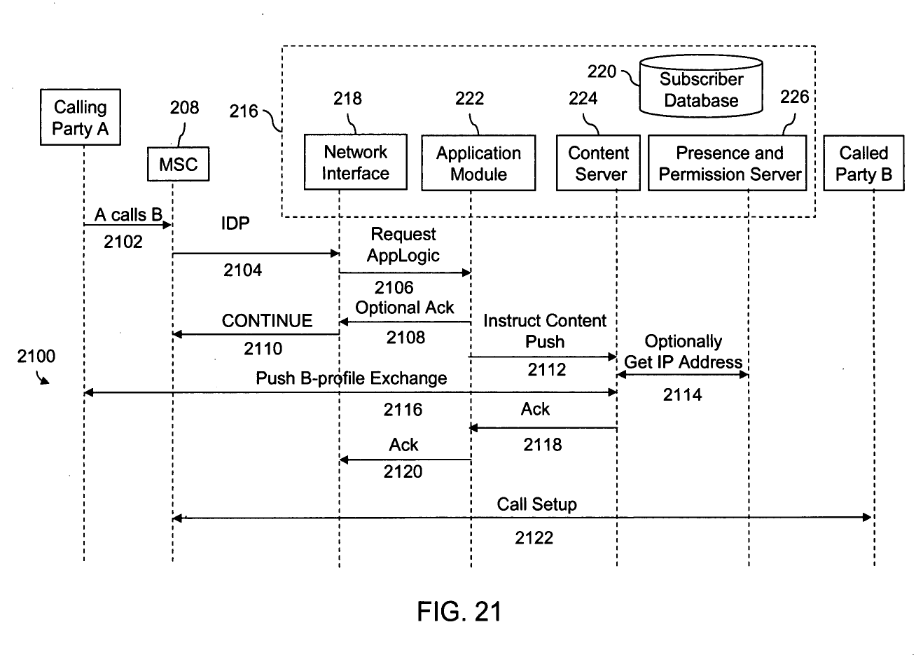

FIG. 21 illustrates the signal flow of the profile of called party being sent to the subscribed calling party in accordance with an embodiment of the present invention. In an embodiment, the signal flow may be based on an originating IN. In another embodiment, the signaling flow may be based on O-CSI-like implementation.

At 2102, calling party A calls called party B. The MSC 208 passes the call control via IN IDP (CAP. INAP etc) command to network interface 218 at 2104. The IDP command includes at least one call parameter. Call parameters may include, but are not limited to, an AppKey=serviceKey, number of calling party A, number of called party B, IMSI of calling party A, and the VMSC location of calling party A. The network interface 218 requests instruction from application module 222 by passing the call parameters at 2106.

The application module 222 applies the application logic identified by the serviceKey using the data from network interface 218 and subscriber database 220 and optionally sends an acknowledgement back to network interface 218 depending on for example, whether application module 222 determines to wait for the delivery of the push content or not at 2108. Upon receiving this acknowledgement, at 2110, network interface 218 may issue an IN CONTINUE command to MSC 208. The application module 222 determines whether the calling party has subscribed to the called party profile service. It obtains the called party B profile content ID which may be obtained by filtering both calling party A and called party B profiles. For example, called party B might block his marriage status from access by calling party A while calling party A might not wish to know called party B's job status. Further, calling party A can also filter out the called party B as a whole since calling party A is not interested in called party B profile at all. The application module 222 determines the calling party A to push content to (in this case, the calling party, but it can also be called party or both) and the called party B profile content ID and sends them to content server 224 to push at 2112. Optionally, content server 224 may communicate with PnP 226 to obtain the IP address of the called party for establishing push content exchange at 2114. PnP 226 returns the IP address of the called party. The content server 224 establishes push called party profile exchange with the calling party at 2116 in accordance with various embodiments described above.

The content server 224 returns an acknowledgement to application module 222 at 2118, which in turn produces a CDR of the calling party by applying accounting logics. The application module 222 returns an acknowledgement to network interface 218 at 2120. The network interface 218 may pass the call control back to MSC 208 using IN CONTINUE at either the first acknowledgement (2108) from application module 222 (for example, in streaming mode of push content) or the second acknowledgement from application module 222. The MSC 208 may continue the call setup at 2122. The calling party device client plays the called party profile before the call is answered or at the incoming call.

It should be noted that the call setup push content service follows a normal call setup for phone conversations. The present invention allows a call party (calling or called) or network (based on called party's subscription) dictated content (e.g. ring tone, news, profiles, stock scores, weather updates, video, music, audible, multimedia messages, email headlines etc) to be pushed to either a calling party or a called party or a third party and played by a client on the receiving party device instead of playing the locally pre-stored content (e.g ring tones, pictures, videos etc) on the device configured by the called party. Furthermore, the call setup push content service does not require a special client on a non-receiving device, rather it requires a special client on the receiving device only.

In an embodiment, since the CTPCS stores the push content, an operator may control the content to be pushed to the receiving party device. For example, the caller will not be able to make indecent/compromising remarks to the receiving party as opposed to Push-To-Talk service. Further, the operator permits a subscriber to upload his/her own recorded thing (music, voice, video etc) to the CTPCS, however, the operator may opt to check out the content first before allowing it on the CTPCS.

The call setup push content service however can leverage the push to talk architecture to facilitate the deployment of the call setup push content service. The client present on the calling device in the push to talk architecture can also be used to transfer the push content from the calling device to the called device or vice versa in a call setup. However, in this scenario, the operator may lose control of the push content. The inter-working push to talk architecture may be used as a foundation for the inter-working of the call setup push content service.

The major difference between the ring forward tone service and push to talk service is that the ring forward tone service is part of a normal call setup while the push to talk service bypasses any call setup. Thus, the ring forward tone service is network controlled ring tone onto the receiving device, while the push to talk service is push-to-talking party's controlled conversation onto the receiving device. While the push to talk service requires clients on both the calling and the called party devices, the ring forward tone service only requires client on the receiving party device.

In an embodiment, the push to talk architecture may form the basis for a possible option of implementing the ring forward tone service. The push to talk architecture may provide presence and availability and contact management which form the basis for the ring forward service client on the receiving party device. Further, the push to talk service can theoretically push/stream any media to the receiving party device as opposed to the ring forward tone service of the present invention in which the RFT can be such a media. When implementing the ring forward tone service, the push to talk architecture can provide another form of ring forward tone service, namely, the calling/called party device with a push to talk client can be extended to send ring tone stored on the device to the CTPCS before streaming down to the receiving party device in parallel to a normal call setup. As a value-add, the push to talk client can help to deliver caller ID end-to-end in an out of band IP communication.

Other Variations

Provided above for the edification of those of ordinary skill in the art, and not as a limitation on the scope of the invention, are detailed illustrations of a call-setup triggered push content system and method. Numerous variations and modifications within the spirit of the present invention will of course occur to those of ordinary skill in the art in view of the embodiments that have now been disclosed. For example, while in the described embodiments, the present invention is implemented primarily from the point of view of GSM mobile networks, the present invention may also be effectively implemented on CDMA, 3G, WCDMA, GPRS, etc., or any other network of common carrier telecommunications in which end users are normally configured to operate within a “home” network to which they normally subscribe, but have the capability of also operating on other neighboring networks.

The examples under the present invention, detailed in the illustrative examples contained here, are described using terms and constructs drawn largely from GSM mobile telephony infrastructure. However, use of these examples should not be interpreted to limiting the invention to those media. The capabilities of the visited or non-accustomed network can be of use and provided through any type of telecommunications medium, including without limitation: (i) any mobile telephony network including, without limitation, GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the call-setup triggered push content system under the present invention, this specification follows the path of a telecommunications call from a calling party to a subscriber or calling party. The present invention provides push content at an attention catching event to the receiving parties and provides richer applications. Further, the content can be pushed to multiple parties and monitored by monitoring services. For the avoidance of doubt, that call can be for a normal voice call, in which the subscriber telecommunications equipment is also capable of visual, audiovisual or motion-picture display. Alternatively, those devices or calls can be for text, video, pictures or other communicated data.

While typical embodiments have been set forth for the purpose of illustration, the foregoing description should not be deemed to be a limitation on the scope of the invention. Accordingly, various modifications, adaptations and alternatives may occur to one skilled in the art without departing from the spirit and scope of the present invention.

Technical References

GSM-902, GSM-340, GSM-378, GSM-978, GSM 379, GSM 318, ITU 1214-1218, ITU 76x, PoC standard references, IMS standard references, SIP standard references

GSM 902 on MAP specification

GSM 340 on SMS

GSM 378 on CAMEL

GSM 978 on CAMEL Application Protocol

GSM 379 on CAMEL Support of Optimal Routing (SOR)

GSM 318 on CAMEL Basic Call Handling

ITU-T Recommendation Q.1214 (1995), Distributed functional plane for intelligent network CS-1.

ITU-T Recommendation Q.1218 (1995), Interface Recommendation for intelligent network CS-1.

ITU-T Recommendation Q.762 (1999), Signaling system No. 7—ISDN user part general functions of messages and signals.

ITU-T Recommendation Q.763 (1999), Signaling system No. 7—ISDN user part formats and codes.

ITU-T Recommendation Q.764 (1999), Signaling system No. 7—ISDN user part signaling procedures.

ITU-T Recommendation Q.766 (1993), Performance objectives in the integrated services digital network application.

ITU-T Recommendation Q.765 (1998), Signaling system No. 7—Application transport mechanism.

ITU-T Recommendation Q.769.1 (1999), Signaling system No. 7—ISDN user part enhancements for the support of Number Portability.

### APPENDIX

| Acronym | Description |
|---|---|
| ACM | Address Complete Message |
| ANM | Answer Message |
| BCD | Binary Coded Decimal |
| CAP | CAMEL Application Part |
| CAMEL | Customized Applications for Mobile network Enhanced Logic |
| CB | Call Barring |
| CC | Country Code |
| CLI | Calling Line Identification |
| CON | IN/CAMEL Connect |
| CSI | CAMEL Subscription Information |
| CUE | IN/CAMEL Continue |
| DPC | Destination Point Code |
| ERB | Event Report Basic call state machine |
| FCI | Furnish Charging Information |
| GGSN | Gateway GPRS Support Node |
| GMSC-H | HPMN Gateway MSC |
| GPRS | General Packet Radio Service |
| GPRS-CSI | GPRS CSI |
| gsmSCF | GSM service control function |
| gsmSSF | GSM service switch function |
| HLR | Home Location Register |
| HLR-H | HLR from HPMN |
| HPMN | Home Public Mobile Network |
| IDP | Initial Detection Point IN/CAP message |
| IMSI | International Mobile Subscriber Identifier |
| IN | Intelligent Network |
| ISD | Insert Subscriber Data |
| ISUP | ISDN User Part |
| LUP | MAP Location Update |
| MAP | Mobile Application Part |
| ME | Mobile Equipment |
| MMS | Multimedia Messaging Service |
| MNC | Mobile Network Code |
| MSC | Mobile Switch Center |
| MSISDN | Mobile Subscriber ISDN |
| MSRN | Mobile Station Roaming Number |
| NDC | National Destination Code |
| O-CSI | Originating CSI |
| ODB | Operator Determined Barring |
| PLN | Prepaid Local Number |
| RRB | Request Report Basic call state machine |
| SCCP | Signal Connection Control Part |
| SCP | Service Control Point |
| SGSN | Service GPRS Support Node |
| SPC | Signal Point Code |
| SRI | Send Routing Information |
| SRI-SM | Send Routing Information for Short Message |
| SS7 | Signaling System 7 |
| SS-CSI | Supplementary Service CSI |
| STP | Signal Transfer Point |
| STP-H | HPMN STP |
| T-CSI | Terminating CSI |
| USSD | Unstructured Supplementary Service Data |
| VLR | Visited Location Register |
| VLR-V | VLR from VPMN |
| VMSC | Visited Mobile Switch Center |
| VMSC-V | VMSC from VPMN |
| VPMN | Visited Public Mobile Network |
| VT-CSI | Visiting network Terminating CSI |

What is claimed is:

1. A method for providing a call setup triggered push content to at least one receiving party via a first telecommunication network, the method comprising:
performing a call control function in response to a call setup initiated by a calling party, wherein a call control function operates on at least one call parameter;
applying application logic based upon the at least one call parameter for determining the at least one receiving party and the corresponding push content details of the at least one receiving party; and
delivering the push content specified by the push content details to the at least one receiving party.

2. The method of claim 1, further comprising playing the delivered push content using a client installed on the at least one receiving party.

3. The method of claim 2, wherein playing comprises playing the delivered push content corresponding to the push content matched on caller ID and received from a known caller ID, if two or more simultaneous calls are received.

4. The method of claim 2, wherein playing comprises playing the delivered push in the order of incoming calls and incoming push contents, if unmatched push content and simultaneous incoming calls from unknown caller IDs are received.

5. The method of claim 1, wherein the at least one call parameters include an application identifier, or a calling party number, or a calling party International Mobile Subscriber Identity (IMSI), or a called party number, or a Visited Mobile Switching Center (VMSC) location or a combination thereof.

6. The method of claim 1, wherein the push content details are defined in preference settings of a subscriber, wherein the preference settings are configured on at least one of the first telecommunication network or the client.

7. The method of claim 6, wherein the preference settings include the identity of a calling party, or the identity of a called party, or a third party identity, or a call history information, or time of the day, or season, or relationships, or a combination thereof.

8. The method of claim 1, wherein the push content includes a ring tone, or a video tone, or a news item, or a stock report, or a sports update, or a quote of the day, or a calling party profile, or a called party profile, or an audio file, or a celebrity voice, or a music item, or a multimedia file, or a television footage, or an advertisement, or incoming email headers, or information of calls related to other calling devices, or a combination thereof.

9. The method of claim 8, wherein the ring tone includes a telecommunication network defined ring tone, an operator-defined ring tone, or a call party defined ring tone, wherein the call party is the calling party, or the called party or a third party.

10. The method of claim 1, wherein the receiving party includes a calling party, or a called party, or a third party or a group of parties.

11. The method of claim 1, wherein delivering the push content comprises at least one of streaming the push content or downloading the push content.

12. The method of claim 1, wherein the push content is defined by a sending party.

13. The method of claim 1, wherein the sending party includes a calling party, or a called party, or a third party or a group of parties.

14. The method of claim 1, wherein the push content is defined based on a history of calls of the at least one receiving party.

15. The method of claim 1, wherein the receiving party has an option to override the push content.

16. The method of claim 1, wherein the push content is protected by digital rights management (DRM).

17. The method of claim 1, wherein the push content is delivered before a call is answered.

18. The method of claim 1, wherein the push content is delivered while a call is in progress.

19. The method of claim 1, wherein the delivery of the push content is suspended when a call is answered.

20. The method of claim 1, wherein the delivery of push content is resumed after a call is completed.

21. The method of claim 1, wherein the delivery of the push content is suspended when a call is answered, and resumed when a call is completed.

22. The method of claim 1, wherein the push content is delivered to the at least one receiving party while a call is initiated by a calling party.

23. The method of claim 1, wherein the push content starts being delivered to the at least one receiving party, and continues after a call is disconnected without call completion.

24. The method of claim 1, wherein the push content delivery is commenced, but discontinued after a call is disconnected without the call being completed.

25. The method of claim 1, wherein the push content is delivered based upon an activity reported by a receiving party device client.

26. The method of claim 25 wherein the activity includes a silent mode, or a switched off ring forward tone mode, or a stored and configured ring forward tone, or a combination thereof.

27. The method of claim 1, wherein provided for the receiving party is at least one of storing, or configuring or purchasing the pushed content is.

28. The method of claim 1, further comprising passing inter-operator content between the first telecommunication network and a second telecommunication network for facilitating inter-working between the first telecommunication network and the second telecommunication network.

29. The method of claim 28, wherein the inter-operator content includes calling party details, or called party details, or a content link.

30. The method of claim 28, wherein the second telecommunication network is the first telecommunication network.

31. The method of claim 1, further comprising retrieving the inter-operator content from the first telecommunication network.

32. A system for providing a call set-up triggered push content to at least one receiving party via a first telecommunication network, the system comprising:
a subscriber database storing at least one subscriber profile and preference settings, the preference settings comprising push content details of the subscriber;
a network interface performing a call control function in response to a call setup, wherein the call control function operates on at least one call parameter;
an application module applying application logic based upon the at least one call parameter for determining the at least one receiving party and the corresponding push content details of the at least one receiving party; and
a content server delivering the push content specified by the push content details to the at least one receiving party.

33. The system of claim 32 further comprising a configuration server enabling configuration of the receiving party subscription and the preference settings.

34. The system of claim 32, further comprising a presence and permission server specifying the presence and preference settings of the at least one receiving party.

35. The system of claim 32 further comprising at least one independent channel for voice and at least one independent channel for data, used in providing the call set-up triggered push content service.

36. The system of claim 32, wherein the receiving party includes a calling party, a called party, a third party or a group of parties.

37. The system of claim 32, wherein the preference settings include the identity of a calling party, or the identity of a called party, or a third party identity, or a call history information, or time of the day, or season, or relationships, or a combination thereof.

38. The system of claim 32, wherein the call parameters include an application identifier, or a calling party number, or a calling party International Mobile Subscriber Identity (IMSI), or a called party number, or a Visited Mobile Switching Center (VMSC) location or a combination thereof.

39. The system of claim 32, wherein the push content is delivered using an out-of-band packet channel.

40. The system of claim 32, wherein the push content is defined by a sending party.

41. The system of claim 40, wherein the sending party includes a calling party, a called party, a third party or a group of parties.

42. The system of claim 32, wherein the network interface is configured to interact the first telecommunication network using a protocol selected from a group comprising Intelligent Network (IN), Customized Applications for Mobile networks Enhanced Logic (CAMEL) Application Part (CAP), Wireless Intelligent Network (WIN), Session Initiation Protocol (SIP), Internet Protocol (IP) Multimedia Subsystem (IMS), or Integrated Services Digital Network (ISDN) User Part (ISUP).

43. The system of claim 32, wherein the application module comprises an accounting module.

44. The system of claim 32, wherein the application module is configured to determine the push content based on a history of calls of the at least one receiving device.

45. The system of claim 32, wherein the content server comprises a push content database comprising the push content.

46. The system of claim 45, wherein the push content database comprises a network-based jukebox.

47. The system of claim 32, wherein the push content includes a ring tone, or a video tone, or a news item, or a stock report, or a sports update, or a quote of the day, or a calling party profile, or a called party profile, or an audio file, or a celebrity voice, or a music item, or a multimedia file, or television footage, or an advertisement, or incoming email headers, or information on calls related to other calling devices, or a combination thereof.

48. The system of claim 32, wherein the ring tone includes a telecommunication network defined ring tone, an operator defined ring tone, and a call party defined ring tone.

49. The system of claim 32, wherein the content server is configured to provide digital rights management implementation.

50. The system of claim 32, wherein the content server is configured to deliver the push content before a call is answered.

51. The system of claim 32, wherein the content server is configured to deliver the push content while a call is in progress.

52. The system of claim 32, wherein the content server is configured to resume delivery of the push content after a call completion.

53. The system of claim 32, wherein the content server is configured to deliver the push content to the at least one receiving party while a call is initiated by a calling party.

54. The system of claim 53, wherein the push content continues to be delivered after the call is disconnected without call completion.

55. The system of claim 32, wherein delivering the push content comprises at least one of streaming the push content, or downloading the push content.

56. The system of claim 32, wherein the receiving party device comprises one of a downloadable client, or an embedded client.

57. The system of claim 56, wherein the receiving party device includes a mobile phone, or a Personal Digital Assistant (PDA) phone, or a smart phone, or a Global System for Mobile Communications (GSM) Wireless Fidelity (Wi-Fi) phone, or a Wi-Fi phone, or a Voice over Internet Protocol (VoIP) phone, or a Session Initiation Protocol (SIP)-based client screen phone, or a VoIP phone, or a screen phone, or a laptop or an IP Multimedia Subsystem (IMS)-based phone.

58. The system of claim 32, wherein the content server is communicatively coupled to the receiving party device client, wherein the content server delivers the push content based upon an activity reported by the receiving party device client.

59. The system of claim 58, wherein the activity includes a silent mode, or a switched off ring forward tone, or a stored and configured ring forward tone, or a combination thereof.

60. The system of claim 32, wherein the content server is configured to receive push content from the sending party.

61. The system of claim 32, wherein the content server is configured to deliver the push content using at least one of a Wireless Application Protocol (WAP) push, or a Short Message Service (SMS) Uniform Resource Locator (URL), or a combination thereof.

62. The system of claim 32, wherein the receiving party is capable of at least one of storing, or configuring or purchasing the push content.

63. The system of claim 32, wherein the first telecommunication network comprises a network offering a Global System for Mobile Communications (GSM), or a Third Generation System for Mobile Communications (3GSM), or an IP Multimedia System (IMS), or a Code Division Multiple Access (CDMA), or a Wireless Fidelity (WiFi), or a Worldwide Interoperability for Microwave Access (WiMAX), or a combination thereof.

64. A system for providing call set-up triggered push content to at least one receiving party via a first telecommunication network, the system comprising:
a subscriber database storing at least one subscriber profile and preference settings, the preference settings comprising the push content details of the subscriber;
a network interface performing a call control function in response to a call set-up, wherein the call control function operates on at least one call parameter;
an application module applying application logic based upon the at least one call parameter for determining the at least one receiving party and the corresponding push content details of the at least one receiving party;
a configuration server enabling configuration of the receiving party subscription and the preference settings;
a presence and permission server specifying the presence and preference settings of the at least one receiving party; and
a content server delivering the push content specified by the push content details to the at least one receiving party.
